(19) United States
(12) Patent Application Publication
(10) Pub. No.: US 2013/0031606 A1
(43) Pub. Date: Jan. 31, 2013

(54) INFORMATION PROCESSING DEVICE, INFORMATION PROCESSING METHOD AND PROGRAM

(71) Applicants: Yuan Wei, Tokyo (JP); Yuichi Kageyama, Tokyo (JP); Norifumi Kikkawa, Tokyo (JP); Mitsuru Takahara, Tokyo (JP)

(72) Inventors: Yuan Wei, Tokyo (JP); Yuichi Kageyama, Tokyo (JP); Norifumi Kikkawa, Tokyo (JP); Mitsuru Takahara, Tokyo (JP)

(73) Assignee: Sony Corporation, Tokyo (JP)

(21) Appl. No.: 13/551,787

(22) Filed: Jul. 18, 2012

(30) Foreign Application Priority Data
Jul. 26, 2011 (JP) 2011-163366

(51) Int. Cl. G06F 15/16; G06F 21/00

(52) U.S. Cl. 726/3; 709/204

(57) ABSTRACT

There is provided an information processing device, including: an acquisition unit for acquiring information transmitted from terminals; and a generation unit for generating a community according to a similarity degree between the information transmitted from a plurality of terminals, wherein, when a plurality of different types of information are transmitted from one terminal, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.

The present disclosure relates to an information processing device, an information processing method and a program, and more particularly, to an information processing device, an information processing method and a program capable of easily generating, for example, a highly convenient (virtual) community.

### BACKGROUND

In the real world (actual world), people form communities such as wedding ceremonies, study meetings, daily lunches, and company meetings. In addition to such communities in the real world, SNSs (Social Network Services), bulletin boards, and the like on networks such as the Internet have been currently spread as virtual world (virtual) communities in order to share information.

Also, proposals for virtual world communities in which real world communities and the virtual world communities can be synchronized with each other, that is, in which only users sharing a space and a time in the real world can participate, has been requested.

For example, users participating in a real world community such as a wedding ceremony can share photographs, videos, messages and the like regarding the bride and groom by participating in a virtual world community synchronized to the wedding ceremony. Further, for example, users participating in a real world community such as a study meeting can share materials of the study meeting by participating in a virtual world community synchronized to the study meeting.

However, in existing SNSs or bulletin boards, there may be a problem of complexity of a procedure for participating in the virtual world community (hereinafter simply referred to as a community, unless otherwise mentioned) or a problem of security.

That is, in existing SNSs, it is necessary that a user becomes an owner (a manager) who manages a community, and invite other users to the community. It is necessary for the invited users to create their accounts or log in using the accounts.

Further, in existing bulletin boards, although it is easier to create a community than in an SNS, it is necessary to send an address of the bulletin board to users who will be invited to the community. Also, in existing bulletin boards, unspecified individuals may access the community.

Various SNSs have been proposed to cope with problems of complexity of a procedure for participation in the community or security as described above.

For example, an SNS in which a community is formed only with users (mobile devices) sharing the same time and the same place using position information or time information in mobile devices having a GPS function, rendering a procedure by which an owner invites others to the community unnecessary, has been proposed in Japanese Patent Laid-Open Publication No. 2010-218524.

Further, a technology in which a USB (Universal Serial Bus) memory for seat detection having a registered ID (Identification) is irremovably installed in a desk of a lecture room in a university, and a student participating in a lesson transfers the ID from the USB memory installed in the desk to a PC (Personal Computer), making information transmission of the student participating in the lesson possible, has been proposed in Japanese Patent Laid-Open Publication No. 2008-257359.

In addition, for a community, performing communication after user IDs are produced in advance and profiles are exchanged (http://jp.techcrunch.com/archives/jp-the-day-sekai-camera-threw-away-camera/) or an application for generating a community using Facebook IDs (http://www.itmedia.co.jp/news/articles/1103/02/news029.html) has been proposed.

Further, in the technologies of Japanese Patent Laid-Open Publication Nos. 2010-218524 and 2008-257359, it is necessary to set an ID for personal authentication using a certain method in advance in order to identify a personal connection. Further, in the technology disclosed in Japanese Patent Laid-Open Publication No. 2008-257359, since the USB memory having the registered ID is irremovably installed in the desk of the lecture room, there is no versatility of location and it is difficult to perform information transmission in places other than the lecture room.

### SUMMARY

For a community, there is a demand for proposal of a technology of easily generating a highly convenient community.

The present technology has been made in view of the circumstances described above, and enables a highly convenient community to be easily generated.

An information processing device or a program of an aspect of the present technology is an information processing device, or a program for causing a computer to function as the information processing device, which includes an acquisition unit for acquiring information transmitted from terminals, and a generation unit for generating a community according to a similarity degree between the information transmitted from a plurality of terminals, wherein when a plurality of different types of information are transmitted from one terminal, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.

An information processing method of an aspect of the present technology is an information processing method, including acquiring information transmitted from terminals, and generating a community according to a similarity degree between the information transmitted from a plurality of terminals, wherein, when a plurality of different types of information are transmitted from one terminal, the generation of the community includes counting, for each of the plurality of types of information, the number of terminals transmitting information similar to the information, and generating a community in which a user of a terminal is permitted to participate, the terminal transmitting information similar to information which the greatest number of terminals transmit information similar to.

In the aspect as described above, information transmitted from terminals is acquired, and a community is generated according to a similarity degree between the information transmitted from a plurality of terminals. In the generation of the community, when a plurality of different types of information are transmitted from one terminal, the terminal number of terminals transmitting information similar to each of the plurality of types of information is counted for each of the plurality of types of information, and a community is generated in which a user of a terminal is permitted to participate, the terminal transmitting information similar to information which the greatest number of terminals transmit information similar to.

Further, the information processing device may be an independent device or may be an internal block that constitutes one device.

Further, the program may be provided through transmission via a transmission medium or after being recorded on a recording medium.

According to an aspect of the present technology, it is possible to easily generate a highly convenient community.

### BRIEF DESCRIPTION OF THE DRAWINGS

FIG. 1 is a block diagram showing an example of a configuration of an embodiment of a community provision system to which the present technology is applied;

FIG. 2 is a diagram illustrating an overview of a process in the community provision system;

FIG. 3 is a block diagram showing an example of a configuration of hardware of a mobile terminal 11;

FIG. 4 is a block diagram showing an example of a functional configuration of the mobile terminal 11;

FIG. 5 is a flowchart illustrating a process in the mobile terminal 11;

FIG. 6 is a block diagram showing an example of a functional configuration of an ASNS server 12;

FIG. 7 is a block diagram showing an example of a configuration of a community management unit 62;

FIG. 8 is a diagram showing an example of a provisional table stored in a provisional registration DB 64;

FIG. 9 is a diagram showing an example of an authentication table stored in a community DB 65;

FIG. 10 is a diagram showing an example of a community table stored in the community DB 65;

FIG. 11 is a diagram showing a provisional table;

FIG. 12 is a diagram showing a provisional table;

FIG. 13 is a diagram showing a provisional table;

FIG. 14 is a diagram showing a provisional table;

FIG. 15 is a diagram showing a provisional table, an authentication table and a community table;

FIG. 16 is a diagram showing a provisional table;

FIG. 17 is a diagram showing a provisional table;

FIG. 18 is a diagram showing a provisional table;

FIG. 19 is a diagram showing a provisional table;

FIG. 20 is a diagram illustrating generation of the community;

FIG. 21 is a diagram illustrating generation of the community;

FIG. 22 is a flowchart illustrating a provisional table registration process;

FIG. 23 is a flowchart illustrating details of common object processing;

FIG. 24 is a flowchart illustrating an authentication ID assignment process;

FIG. 25 is a flowchart illustrating a community generation process;

FIG. 26 is a flowchart illustrating a security process;

FIG. 27 is a flowchart illustrating a security process;

FIG. 28 is a diagram illustrating a process in which the community provision system provides a community;

FIG. 29 is a flowchart illustrating a process in the mobile terminal 11 when a user desiring to participate participates in a community midway using a first midway participation method;

FIG. 30 is a flowchart illustrating a process in an ASNS server 12 when a user desiring to participate participates in a community midway using the first midway participation method;

FIG. 31 is a diagram illustrating a process in the community provision system when a user desiring to participate participates in a community midway using the first midway participation method;

FIG. 32 is a flowchart illustrating a process in the mobile terminal 11 when a user desiring to participate participates in a community midway using a second midway participation method;

FIG. 33 is a flowchart illustrating a process in an ASNS server 12 when a user desiring to participate participates in a community midway using the second midway participation method; and

FIG. 34 is a diagram illustrating a process in the community provision system when the user desiring to participate participates in the community midway using the second midway participation method.

### DETAILED DESCRIPTION OF THE EMBODIMENT(S)

### Embodiment of Community Provision System to which the Present Technology is Applied

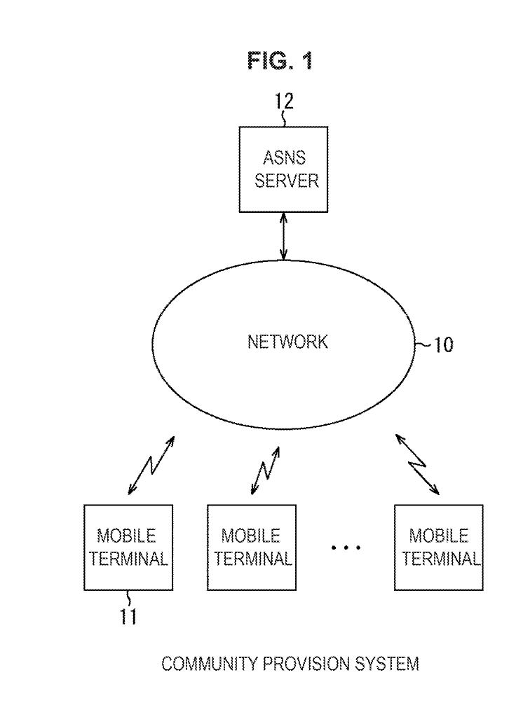

FIG. 1 is a block diagram showing an example of a configuration of an embodiment of a community provision system to which the present technology is applied.

In FIG. 1, the community provision system includes a network 10, a plurality of mobile terminals 11, and an ASNS server 12.

The network 10 is a network, such as the Internet, to which the ASNS server 12 is connected.

The mobile terminal 11 is, for example, a portable tablet terminal such as a portable game machine, a mobile phone or a smart phone, or a terminal that can be carried by a user, such as a laptop PC. The mobile terminal 11 has a function of performing communication with the ASNS server 12 via the network 10.

Further, either wireless communication or wired communication may be employed as communication between the network 10 and the mobile terminal 11.

The ASNS server 12 provides the user of the mobile terminal 11 with a temporary community in which only certain users present on the spot can participate (access) and which realizes secure communication by communicating with the mobile terminal 11 via the network 10.

Here, service of providing a community (temporary community) in the ASNS server 12 is also referred to as an ASNS (Adhoc SNS).

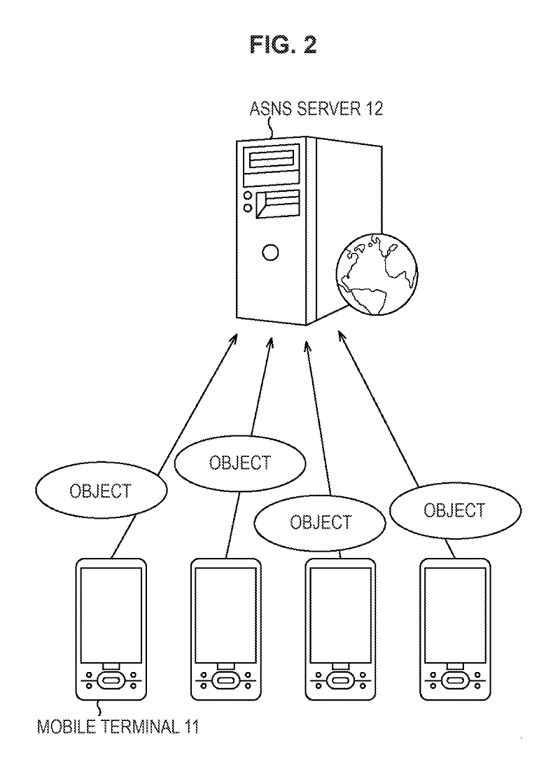

FIG. 2 is a diagram illustrating an overview of a process in the community provision system of FIG. 1.

A user desiring to participate in the community manipulates the mobile terminal 11 owned by the user to transmit, for example, an object that is position information of a current place acquired by GPS (Global Positioning System) or information such as a predetermined image, voice (sound) or text to the ASNS server 12.

The ASNS server 12 receives the objects from the mobile terminals 11 and generates a community in which only users of the mobile terminals 11 transmitting the common (similar) objects at substantially the same time among the mobile terminals 11 transmitting the objects can participate.

Accordingly, for example, as long as a plurality of users sharing a space and time in the real world transmit the common objects to the ASNS server 12 by manipulating the mobile terminals 11 owned by the respective users, the ASNS server 12 generates a community in which only the users of the mobile terminals 11 transmitting the common objects can participate.

Further, the ASNS server 12 transmits a community ID, which is a temporary ID for identifying the community in which the only users of the mobile terminals 11 transmitting the objects common to one another can participate, to the mobile terminals 11 transmitting the common objects, and transmits a terminal ID that is a temporary ID for identifying (the user of) the mobile terminal 11 participating in the community to each mobile terminal 11.

The mobile terminal 11 transmitting the common object receives the terminal ID of the mobile terminal 11 and the community ID of the community in which (the user of) the mobile terminal 11 participates. Also, using the terminal ID and the community ID, the mobile terminal 11 can participate in (access) the community identified by the community ID.

Here, the objects that a plurality of users transmit to the ASNS server 12 by manipulating the mobile terminals 11 owned by the respective users with the purpose of generation of the community and the participation in the community should have commonality (similarity). The object that the user transmits to the ASNS server 12 by manipulating the mobile terminal 11 with the purpose of generation of the community and the participation in the community is also referred to as a common object.

In the ASNS server 12, the common object is used for user authentication necessary for the user to participate in the community.

That is, when a plurality of common objects received at substantially the same time are similar to one another (have commonality), the ASNS server 12 generates a community in which only the users of the mobile terminals 11 transmitting the common objects similar to one another are permitted to participate.

Accordingly, it is not necessary for an owner to invite a user to the community in the community generated by the ASNS server 12.

An object used as the common object is preferably information that can be obtained by only users sharing a space and a time in the real world and desiring to participate in the community (information difficult to obtain by a person not present on the spot).

Accordingly, for example, a photograph or a video obtained by photographing a person present on the spot, a photograph or a video obtained by photographing a landscape on the spot with a predetermined composition, text or voice as a password determined on the spot, position information of a current place acquired using a GPS function when the mobile terminal 11 has the GPS function, or the like may be employed as the common object.

Further, the ASNS server 12 makes the determination of the similarity (the similarity determination) as to whether a plurality of common objects are similar to one another, but a similarity determination method depends on types of the common objects (e.g., a difference between media such as text, image, and voice) and changes with evolution of science and technology.

If the common objects are, for example, passwords of texts, the passwords as the plurality of common objects can be determined to be similar to one another when the texts as the passwords completely match.

Further, if the common objects are, for example, photographs obtained by photographing persons (personal photographs), the personal photographs as a plurality of common objects can be determined to be similar to one another other when a similarity degree indicating a degree of persons reflected in the personal photograph being similar to one another is equal to or more than a predetermined threshold.

Further, if the common objects are, for example, photographs obtained by photographing a landscape on the spot with the same composition, the photographs as a plurality of common objects can be determined to be similar to one another when a similarity degree among all the photographs is equal to or more than a predetermined threshold.

Further, if the common objects are, for example, sounds on the spot (environmental sounds), environmental sounds as a plurality of common objects can be determined to be similar to one another when a similarity degree between waveforms of the environmental sounds is equal to or more than a predetermined threshold.

Further, if the common objects are, for example, videos (videos with voices) obtained by photographing one scene on the spot, videos as a plurality of common objects can be determined to be similar to one another when a similarity degree between images as the videos is equal to or more than a predetermined threshold and a similarity degree between waveforms of voices with which the videos are accompanied is equal to or more than a predetermined threshold.

Further, if the common objects are, for example, position information of a current place, position information as a plurality of common objects can be determined to be similar when a distance between positions indicated by the position information is within a predetermined threshold.

Further, a plurality of objects may be employed as the common objects. That is, for example, a plurality of the same type of objects such as a first photograph captured with a first composition and a second photograph captured with a second composition or a plurality of different types of objects such as position information and videos may be employed as common objects.

If a plurality of objects are employed as the common objects, when the plurality of objects are similar, that is, for example, position information and videos are employed as common objects, the ASNS server 12 determines that common objects are similar to each other when the position information is similar and the videos are similar to each other.

As described above, for example, when the plurality of objects such as the position information and the videos are employed as the common objects, the position information are similar to each other, and the videos are similar to each other, a securer community can be generated when the common objects are determined to be similar to each other, as compared to when one object is used as a common object.

Further, the ASNS server 12 determines a similarity between a plurality of common objects received at substantially the same time. If it is determined that the plurality of common objects are similar to one another, a community in which only the users of the mobile terminals 11 transmitting the similar common objects are permitted to participate is generated. In the generation of the community, common objects determined to be similar to one another are assumed to be objects for the community generation.

In the ASNS server 12, when a common object is received from the mobile terminal 11 of a user that does not yet participate in the community (hereinafter also referred to as a non-participation user) after the community is generated, if such a common object is similar to the object for community generation, participation of the non-participation user in the community (access to the community from the mobile terminal 11 of the non-participation user) can be permitted.

In this case, it is possible to improve security of the community by limiting a time limit within which the participation of the non-participation user transmitting the common object similar to the object for community generation in the community is permitted to a certain period of time after the generation of the community.

### [Example of Configuration of Hardware]

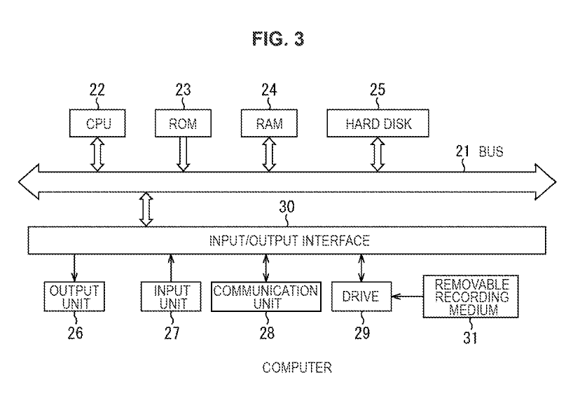

FIG. 3 is a block diagram showing an example of a configuration of hardware of the mobile terminal 11 of FIG. 1.

In FIG. 3, the mobile terminal 11 includes a bus 21, a CPU (Central Processing Unit) 22, a ROM (Read Only Memory) 23, a RAM (Random Access Memory) 24, a hard disk 25, an output unit 26, an input unit 27, a communication unit 28, a drive 29, an input/output interface 30, and a removable recording medium 31.

The CPU 22 to the hard disk 25 are connected to the input/output interface 30 via the bus 21. The CPU 22 to the hard disk 25 and (devices connected to) the input/output interface 30 can exchange data with each other via the bus 21.

Further, the output unit 26 to the drive 29 are connected to the input/output interface 30, and accordingly, the CPU 22 to the drive 29 can exchange the data with each other via the bus 21 and the input/output interface 30.

The CPU 22 performs various processes by executing a program stored in the ROM 23 or a program read from the hard disk 25 and stored (developed) in the RAM 24.

The ROM 23 is, for example, an EEPROM (Electrically Erasable Programmable ROM), and stores data or programs that are necessary to be held even when the mobile terminal 11 is powered off.

The RAM 24 stores programs or data necessary for operation of the CPU 22.

Programs executed by the CPU 22 or various data are recorded in the hard disk 25.

The output unit 26 is, for example, a display device, such as a liquid crystal panel, and a speaker, and displays an image and outputs sound.

The input unit 27 is, for example, a keyboard, a pointing device such as a tablet (touch screen), or the like. The input unit 27 is manipulated by a user and outputs data (a signal) according to the manipulation.

The communication unit 28 is, for example, a communication interface such as a LAN (Local Area Network), and controls wireless or wired communication with an external device.

The removable recording medium 31, which is an optical disc such as a DVD (Digital Versatile Disc) or a semiconductor memory such as USB memory, is detachably mounted on the drive 29.

The drive 29 drives the removable recording medium 31 mounted thereon to record data on the removable recording medium 31 and read the data from the removable recording medium 31.

The input/output interface 30 functions as an interface for connecting various devices to the mobile terminal 11. In FIG. 3, the bus 21, and the output unit 26 to the drive 29 are connected to the input/output interface 30 as described above, but other devices may be connected to the input/output interface 30.

In the mobile terminal 11 configured as described above, for example, a client program (a client application), which is a program at an ASNS client side, is installed on the hard disk 25.

The CPU 22 performs various processes by executing the program installed in the hard disk 25.

Further, the program may be installed on the hard disk 25 in advance.

Further, the program may be stored (recorded) in the removable recording medium 31 and installed in the mobile terminal 11 from the removable recording medium 31. Such a removable recording medium 31 may be provided as so-called package software.

Further, the program may be installed in the mobile terminal 11 from the removable recording medium 31 or may be downloaded to the mobile terminal 11 via a communication network or a broadcasting network and installed on the embedded hard disk 25. That is, the program, for example, may be wirelessly transmitted from a download site to the mobile terminal 11 via an artificial satellite for digital satellite broadcasting or may be transmitted to the mobile terminal 11 in a wired manner via a network such as a LAN or the Internet.

Here, the ASNS server 12 (FIG. 1), as well as the mobile terminal 11, may be configured as shown in FIG. 3.

However, the program installed in the hard disk 25 is different between the mobile terminal 11 and the ASNS server 12. A server program (server application), which is a program at an ASNS server side, rather than the client program (client application), is installed in the ASNS server 12.

### [Example of Functional Configuration of Mobile Terminal 11]

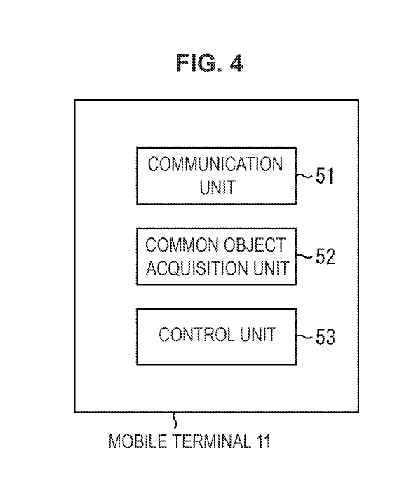

FIG. 4 is a block diagram showing an example of a functional configuration of the mobile terminal 11 in FIG. 1.

The mobile terminal 11 has an equivalent functional configuration of FIG. 4 and performs various processes by the CPU 22 (FIG. 3) executing the client program.

In FIG. 4, the mobile terminal 11 includes a communication unit 51, a common object acquisition unit 52, and a control unit 53.

The communication unit 51 performs communication with the ASNS server 12 via the network 10 (FIG. 1). Also, the communication unit 51 may perform communication with another mobile terminal 11 via, for example, WiFi (registered trademark)-direct, infrared, Bump (registered trademark), 3G Bluetooth (registered trademark) or proximity communication such as NFC (Near Field Communication).

The common object acquisition unit 52, for example, acquires a common object according to a user manipulation.

That is, the common object acquisition unit 52 has, for example, a GPS function, and acquires position information of a current place as a common object. Further, the common object acquisition unit 52 is, for example, a camera or a microphone, and acquires a video, a photograph as a still image, or voice as the common object. Further, the common object acquisition unit 52 is, for example, a keyboard or a voice recognition device, and acquires a text input when a user manipulates the keyboard or text obtained by recognizing voice uttered by the user using a voice recognition device, as the common object.

In addition, the common object acquisition unit 52 can acquire a file such as a video, a photograph, a voice or text stored in the mobile terminal 11 as the common object.

The control unit 53 controls the overall mobile terminal 11.

### [Process in Mobile Terminal 11]

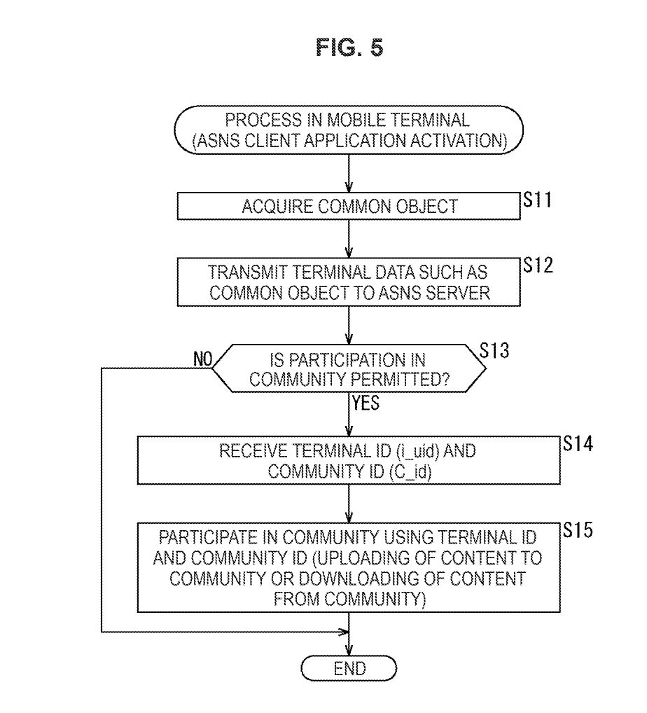

FIG. 5 is a flowchart illustrating a process in the mobile terminal 11 of FIG. 4.

A user desiring to participate in the community activates, for example, the client program and then manipulates the mobile terminal 11 owned by the user to acquire a common object.

The mobile terminal 11 activates the client program according to a user manipulation, and functions as an ASNS client through the configuration shown in FIG. 4.

That is, in step S11, the common object acquisition unit 52 (FIG. 4) acquires a common object, for example, according to a user manipulation, and the process proceeds to step S12.

In step S12, the communication unit 51 (FIG. 4) transmits data requested by the ASNS server 12, which contains the common object acquired by the common object acquisition unit 52, to the ASNS server 12, and the process proceeds to step S13.

Here, the data containing the common object that the communication unit 51 of the mobile terminal 11 transmits to the ASNS server 12 is also referred to as terminal data.

In step S13, the control unit 53 (FIG. 4) determines whether participation in (access to) the community is permitted by the ASNS server 12.

If it is determined in step S13 that the participation in the community has not been permitted, that is, if a community ID (C_id) for identifying the community and a terminal ID (i-uid) for identifying the mobile terminal 11 have not been transmitted from the ASNS server 12 as will be described later, the process skips steps S14 and S15 and ends.

Further, if it is determined in step S13 that the participation in the community has been permitted, that is, when the community ID (C_id) and the terminal ID (i-uid) have been transmitted from the ASNS server 12, the process proceeds to step S14 in which the communication unit 51 receives the community ID and the terminal ID from the ASNS server 12. The process proceeds to step S15.

In step S15, the control unit 53 participates in the community using the community ID and the terminal ID received by the communication unit 51.

That is, the control unit 53 uploads, for example, content, such as image data such as photographs or videos or profiles such as E-mail addresses of users, to a community identified by the community ID generated on the ASNS server 12 via the network 10, for example, by controlling the communication unit 51 according to a user manipulation.

Further, the control unit 53, for example, controls the communication unit 51 according to a user manipulation to download content from the community identified by the community ID.

In the community, exchange of messages between the users participating in the community may be performed, in addition to the upload and download of content. When the message exchange via the community is performed, the control unit 53 controls the message exchange.

### [Example of Functional Configuration of ASNS Server 12]

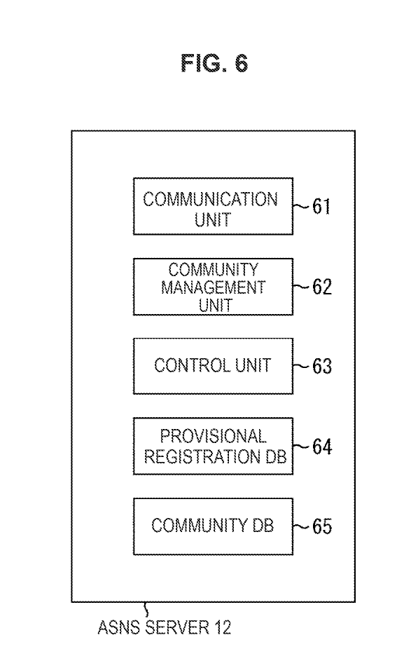

FIG. 6 is a block diagram showing an example of a functional configuration of the ASNS server 12 of FIG. 1.

The ASNS server 12 has the equivalent functional configuration of FIG. 6 by the CPU 22 (FIG. 3) executing the server program, and performs various processes.

In FIG. 6, the ASNS server 12 includes a communication unit 61, a community management unit 62, a control unit 63, a provisional registration DB (DataBase) 64, and a community DB 65.

The communication unit 61 performs communication with the mobile terminal 11 via the network 10 (FIG. 1).

The community management unit 62, for example, performs community management, in addition to the generation of the community, based on data stored in the provisional registration DB 64 or the community DB 65.

The control unit 63 controls the overall ASNS server 12.

The provisional registration DB 64 stores a provisional table, which will be described later.

The community DB 65 stores an authentication table and a community table, which will be described later.

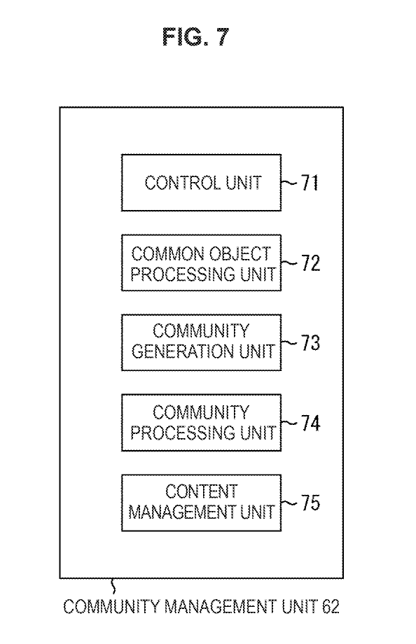

FIG. 7 is a block diagram showing an example of a configuration of the community management unit 62 of FIG. 6.

In FIG. 7, the community management unit 62 includes a control unit 71, a common object processing unit 72, a community generation unit 73, a community processing unit 74, and a content management unit 75.

The control unit 71 controls the overall community management unit 62.

The common object processing unit 72 acquires the common object transmitted from the mobile terminal 11 to the ASNS server 12, and performs calculation of a similarity degree (distance) between the common objects, a determination of similarity between the common objects based on the similarity degree, and a process for the common objects.

The community generation unit 73 generates a community according to the similarity degree between the common objects from the mobile terminal 11.

That is, if it is determined that the common objects are similar to each other in the determination of the similarity based on a similarity degree between the common objects transmitted from the mobile terminal 11 to the ASNS server 12, that is, when the common objects received from a plurality of mobile terminals 11 are similar to one another, the community generation unit 73 generates a community in which (users of) the mobile terminals 11 transmitting the similar common objects are permitted to participate.

Here, an entity of the community is a storage area secured on a memory (e.g., the RAM 24 of FIG. 3). (The mobile terminal 11 of) The user participating in the community may perform uploading or downloading of content, exchange of a message with another user, and the like using a storage area as the community.

The community processing unit 74 manages the community generated by the community generation unit 73. That is, the community processing unit 74 performs, for example, control of storing of content uploaded (transmitted) from the mobile terminal 11 of the user participating in the community, in the community, reading of content requested to be downloaded by the mobile terminal 11 from the community, and message transmission and reception for the exchange of a message between users via the community.

The content management unit 75 manages content uploaded to the community. That is, the content management unit 75, for example, enables only a content owner (the user uploading the content) to delete the content uploaded to the community. Also, the content management unit 75, for example, enables only users authorized by the content owner to download the content uploaded to the community.

### [Provisional Table]

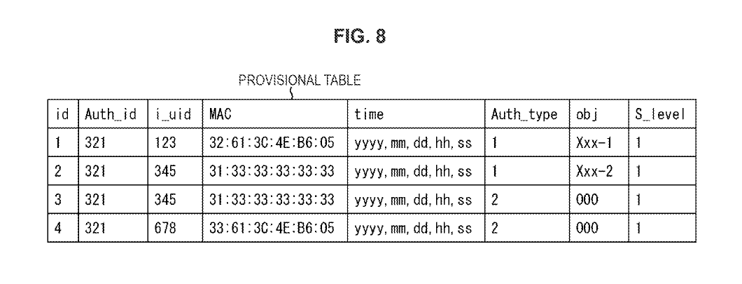

FIG. 8 is a diagram showing an example of the provisional table stored in the provisional registration DB 64 of FIG. 6.

When the terminal data is transmitted from the mobile terminal 11 and received by the communication unit 61 (FIG. 6), the community generation unit 73 (FIG. 7) of the community management unit 62 newly registers one entry (record) for one terminal data in the provisional table.

In (the entries of) the provisional table, id, Auth_id, i_uid, MAC, time, Auth_type, obj, and S_level are registered.

In the provisional table, id is identification information for distinguishing among (identifying) the entries of the provisional table (hereinafter also referred to as a provisional table ID).

When a new entry is registered in the provisional table, the community generation unit 73 assigns a provisional table ID to the new entry. In FIG. 8, a number unique to each entry is used as an id of the provisional table (a provisional table ID).

Auth_id is identification information (hereinafter also referred to as authentication ID) for distinguishing among groups to group (entries for) a plurality of terminal data whose common objects are similar to one another into the groups.

That is, the common object is contained in the terminal data that the mobile terminal 11 transmits to the ASNS server 12, as described with reference to FIG. 5, and when common objects contained in respective terminal data transmitted from a plurality of mobile terminals 11 are similar to one another, the community generation unit 73 regards a plurality of users (of the mobile terminals 11) transmitting the similar common objects as being successful in authentication for participation in the community, and assigns the same authentication ID (Auth_id) to the entries for respective terminal data from the plurality of mobile terminals 11.

In FIG. 8, a number unique to each group is used as the authentication ID (Auth_id).

i_uid is identification information for identifying (the user of) the mobile terminal 11 transmitting the terminal data (hereinafter also referred to as a terminal ID).

When registering the entry for one terminal data in the provisional table, the community generation unit 73 assigns a temporary ID to the mobile terminal 11 transmitting the terminal data as the terminal ID (i_uid).

In FIG. 8, a number unique to (the user of) each mobile terminal 11 transmitting the terminal data is used as the terminal ID (i_uid).

Here, since the terminal ID (i_uid) is unique to (the user of) each mobile terminal 11 as described above, when the entry for the terminal data transmitted from any mobile terminal 11 has already been registered in the provisional table, the same terminal ID as the terminal ID assigned to the entry already registered for the same mobile terminal 11 is assigned to the entry for retransmitted terminal data when the terminal data is retransmitted from the same mobile terminal 11.

In FIG. 8, the same terminal ID (i_uid) of 345 is registered in the entries whose provisional table IDs (id) are 2 and 3. The entries whose provisional table IDs (id) are 2 and 3 are entries registered for first terminal data and second terminal data when transmission data is transmitted twice from (the user of) the same mobile terminal 11.

The MAC indicates a MAC address of the mobile terminal 11 transmitting the terminal data, and time indicates a time (date and time) when the entry was registered in the provisional table.

Auth_type indicates information used for authentication for participation in the community, that is, a type of the common object (media).

When the community generation unit 73 registers the entry for the terminal data in the provisional table, the community generation unit 73 recognizes a type of the common object contained in the terminal data and registers information indicating the type as Auth_type.

Here, for example, Auth_type having a value 1 indicates that the common object is, for example, a photograph. Further, for example, Auth_type having a value 2 indicates that the common object is, for example, voice, and for example, Auth_type having a value 3 indicates that the common object is, for example, a video. Further, for example, Auth_type having a value 4 indicates that the common object is, for example, position information, and for example, Auth_type having a value 5 indicates that the common object is, for example, text. Further, for example, Auth_type having a value 9 indicates that the common object is, for example, a token that includes a series of letters.

obj is the common object contained in the terminal data from the mobile terminal 11 (or, URI (Uniform Resource Identifier) of a file name of the common object).

S_level is a security level indicating security of the community, that is, severity (stringency) of authentication for participation in the community.

The security level includes, for example, level 1 (a first level) indicating that the security is loose, level 2 (a second level) indicating that the security is neither loose nor strict (usual), and level 3 indicating that the security is strict.

In the security level of level 1, it is permitted (accepted) for common objects transmitted from the respective mobile terminals 11 of a plurality of users participating in the community to be different types of objects.

Accordingly, in the security level of level 1, for example, the users transmitting different types of common objects, such as a user (of the mobile terminal 11) transmitting the terminal data containing a photograph as a common object and a user transmitting the terminal data containing voice as the common object, can participate in the same community, as will be described later.

In the security level of level 2, it is necessary for common objects transmitted from the respective mobile terminals 11 of a plurality of users participating in the community to be the same types of objects.

Accordingly, in the security level of level 2, for example, the users transmitting different types of common objects, such as a user transmitting the terminal data containing a photograph as the common object and a user transmitting the terminal data containing voice as the common object, are difficult to easily participate in the same community.

In the security level of level 3, it is necessary for (terminal data containing) two or more common objects to be transmitted from the respective mobile terminals 11 of a plurality of users participating in the community.

Also, in the security level of level 3, when two or more respective common objects transmitted by (the mobile terminal 11 of) a user are similar to two or more respective common objects transmitted by the other user, the users are permitted to participate in the community.

Further, two or more common objects necessary in the security level of level 3 may be the same types of objects or may be different types of objects.

Here, the MAC address of the mobile terminal 11 and the security level (S_level) are contained in the terminal data from the mobile terminal 11, in addition to the common object (obj). The community generation unit 73 registers, in the provisional table, the common object (obj), the MAC address, and the security level (S_level) contained in the terminal data.

Further, the security level (S_level) may be contained in the terminal data according to a user manipulation to designate the security level in the mobile terminal 11. When the user does not make the manipulation to designate the security level, a default security level may be contained in the terminal data in the mobile terminal 11.

When the default security level is contained in the terminal data, the community generation unit 73 registers, for example, level 1 as the default security level in the provisional table.

Further, in the community generation unit 73, the default security level may be set, for example, based on position information of a current place of the mobile terminal 11.

That is, in the mobile terminal 11, the position information of the current place of the mobile terminal 11 is contained in the terminal data. The community generation unit 73 may set the default security level to, for example, level 1 or level 3 based on the position information contained in the terminal data.

Specifically, when the position information of the mobile terminal 11 indicates, for example, a place that unspecified persons access, such as a wedding hall or a restaurant, level 1 in which the security is loose may be set as the default security level.

Further, when the position information of the mobile terminal 11 indicates, for example, a place that specific persons access, such as a conference room of a company, level 3 in which the security is strict may be set as the default security level.

Further, for example, a level in which common objects necessary for authentication are different according to the current place of the mobile terminal 11 may be employed as the security level, in addition to levels 1 to 3 described above.

### [Authentication Table]

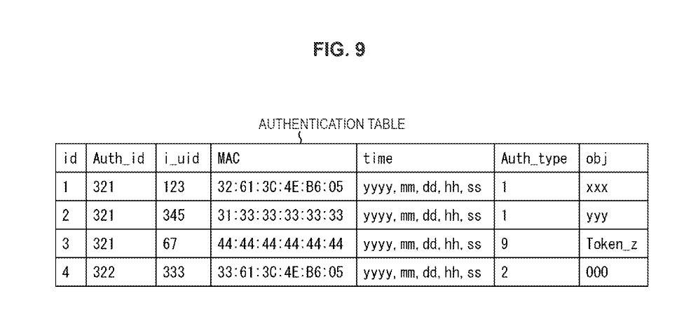

FIG. 9 is a diagram showing an example of the authentication table stored in the community DB 65 of FIG. 6.

If authentication of (a user transmitting the terminal data of) the entry registered in the provisional table is successful, the community generation unit 73 (FIG. 7) newly registers, for data registered in the entry (entry data) whose authentication for has been successful, that is, entry data to which the authentication ID has been assigned (hereinafter also referred to as authentication success data), an entry in the authentication table (registers an entry corresponding to the entry of the provisional table to which the authentication ID has been assigned, in the authentication table).

id, Auth_id, i_uid, MAC, time, Auth_type, and obj are registered in (entries of) the authentication table.

In the authentication table, id is identification information for distinguishing among the entries of the authentication table (hereinafter also referred to as authentication table ID).

When the community generation unit 73 registers a new entry in the authentication table, the community generation unit 73 assigns an authentication table ID to the new entry. In FIG. 9, a number unique to each entry is used as the id of the authentication table (the authentication table ID).

Further, the authentication table ID is a separate independent ID from the provisional table ID.

Auth_id is the authentication ID described with reference to FIG. 8, and the community generation unit 73 registers, in the entry of the authentication table, an authentication ID contained in the authentication success data for such an entry (data of the entry of the provisional table to which the authentication ID has been assigned).

i_uid is the terminal ID described with reference to FIG. 8, and the community generation unit 73 registers, in the entry of the authentication table, the terminal ID contained in the authentication success data for the entry.

The MAC indicates a MAC address, and the community generation unit 73 registers, in the entry of the authentication table, a MAC address contained in the authentication success data for the entry.

time indicates time (date and time) when the entry was registered in the authentication table.

Auth_type indicates a type of the common object as in FIG. 8, and the community generation unit 73 registers, in the entry of the authentication table, Auth_type contained in the authentication success data for the entry.

obj is a common object as in FIG. 8, and the community generation unit 73 registers, in the entry of the authentication table, the common object (obj) contained in the authentication success data for the entry.

### [Community Table]

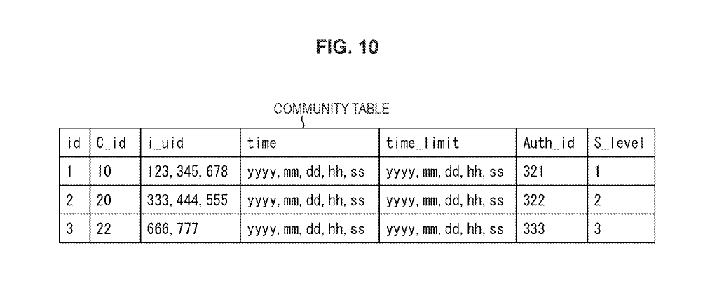

FIG. 10 is a diagram showing an example of a community table stored in the community DB 65 of FIG. 6.

When there are entries to which the same authentication ID (Auth_id) is assigned among the entries registered in the authentication table, the community generation unit 73 (FIG. 7) generates a community in which a user (of the mobile terminal 11 transmitting the terminal data as a source of the entry) to which the same authentication ID has been assigned can participate.

That is, the community generation unit 73 secures a storage area as the community in which users to which the same authentication ID has been assigned can participate.

Further, the community generation unit 73 newly registers, for the community in which the users to which the same authentication ID has been assigned can participate, an entry of community data for managing the community in the community table (registers entries corresponding to the entries of the authentication table to which the same authentication ID has been assigned, in the community table).

id, C_id, i_uid, time, time_limit, Auth_id and S_level are registered as community data in (the entry of) the community table.

In the community table, id is identification information for distinguishing among the entries of the community table (hereinafter also referred to as a community table ID).

When the community generation unit 73 registers a new entry in the community table, the community generation unit 73 assigns the community table ID to the new entry. In FIG. 10, a number unique to each entry is used as an id of the community table (community table ID).

Further, the community table ID is a separate independent ID from the provisional table ID and the authentication table ID.

C_id is identification information (hereinafter also referred to as community ID) for distinguishing among communities managed by the community data of the entry (the entry in which C_id is registered), and the community generation unit 73 assigns a unique community ID (C_id) to a community when generating the community.

i_uid is the terminal ID described with reference to FIG. 8, and the community generation unit 73 registers (a list of) the terminal IDs assigned to (the mobile terminals 11 of) the users that can participate in the community indicated by the community ID (C_id), as i_uid of the community table.

time indicates time (date and time) when the entry was registered in the community table.

time_limit indicates a time limit within which the participation in the community can be requested. The community generation unit 73 registers, for example, a time obtained by adding a predetermined time to the time of the entry of the community table, in time_limit.

After a time indicated by time_limit has elapsed, the user whose terminal data in the provisional table has been registered is not authorized to participate in the community even when his or her common object is similar to the common object of the user that can participate in the community (the terminal ID and the community ID are not provided from the ASNS server 12).

Auth_id is the authentication ID described with reference to FIG. 8, and the community generation unit 73 registers an authentication ID assigned to the user that can participate in the community indicated by the community ID of the community table (the community specified by the community ID), in Auth_id of the community table.

S_level is a security level described with reference to FIG. 8, and the community generation unit 73 registers a security level contained in the terminal data transmitted from (the mobile terminal 11 of) the user that can participate in the community indicated by the community ID of the community table in S_level of the community table.

Further, when the security levels contained in the terminal data transmitted from the users who can participate in the community indicated by the community ID of the community table (hereinafter also simply referred to as participating users) match, the matching security level is registered in S_level of the community table.

When the security levels contained in the terminal data transmitted from the participating users do not match, for example, the strictest security level (a level having a great value) among the security levels contained in the terminal data transmitted from the participating user is registered in S_level of the community table.

### [Registration of Data in Provisional Table, Authentication Table and Community Table]

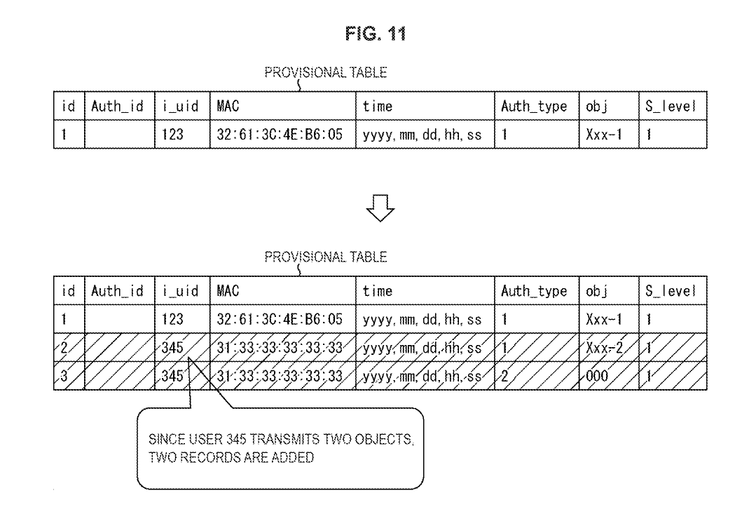

FIGS. 11 to 21 are diagrams illustrating registration of data (entries) in the provisional table, the authentication table and the community table performed in the community generation unit 73 of the ASNS server 12.

FIG. 11 is a diagram showing the provisional table.

When terminal data is transmitted from (the mobile terminal 11 of) a certain user U#1 to the ASNS server 12, the community generation unit 73 assigns a terminal ID (i_uid) to the user U#1 transmitting the terminal data, and registers an entry having a provisional table ID (id) of, for example, 1 for the terminal data from the user U#1 in the provisional table, as shown in FIG. 11.

Hereinafter, appropriately, the entry having the provisional table ID (id) of a value k registered in the provisional table is described as a provisional table entry #k. In FIG. 11, the terminal ID (i_uid) having a value 123 is assigned to the user U#1.

Then, another user U#2 is assumed to transmit terminal data to the ASNS server 12 twice.

In this case, the community generation unit 73 also assigns the terminal ID (i_uid) to the user U#2 transmitting the terminal data, and registers entries for the two terminal data from the user U#2 in the provisional table.

In FIG. 11, the entry having the provisional table ID (id) of 2 (a provisional table entry #2) is registered for the first terminal data among the two terminal data from the user U#2 in the provisional table, and the entry having a provisional table ID (id) of 3 (a provisional table entry #3) is registered for the second terminal data in the provisional table.

Further, in FIG. 11, a terminal ID (i_uid) having a value 345 is assigned to the user U#2.

Since both the provisional table entries #2 and #3 are entries registered for the terminal data from the user U#2, i_uid for the entries are 345, which is a value assigned to the user U#2.

Further, in FIG. 11, since the user U#1 has transmitted the terminal data containing the common object of a photograph, Auth_type of the provisional table entry #1 is 1, which is a value indicating the photograph.

Further, in FIG. 11, since the user U#2 has transmitted the first terminal data containing a common object of a photograph and the second terminal data containing a common object of voice, Auth_type of the provisional table entry #2 is 1, which is the value indicating the photograph, and Auth_type of the provisional table entry #3 is 2, which is a value indicating the voice.

Now, if the common object of the photograph contained in the terminal data from the user U#1 is similar to the common object of the photograph contained in the first terminal data from the user U#2, the community generation unit 73 regards the users U#1 and U#2 transmitting the similar common objects as being successful in authentication for participation in the community and assigns the same authentication ID (Auth_id) to the provisional table entry #1 for the terminal data from the user U#1 and the provisional table entry #2 for the first terminal data from the user U#2, which contain the similar common objects.

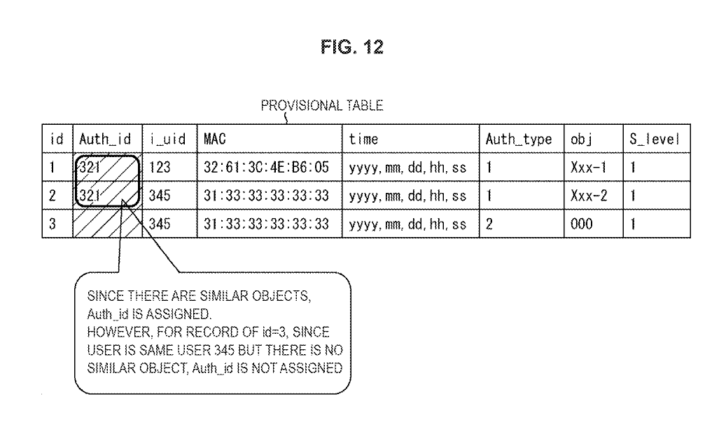

FIG. 12 is a diagram showing the provisional table after the same authentication ID has been assigned to the provisional table entries #1 and #2.

In FIG. 12, the authentication ID (Auth_id) having a value 321 is assigned to the provisional table entries #1 and #2.

Further, in FIG. 12, since an entry of a common object similar to the common object of the voice contained in the second terminal data from the user U#2 has not been registered in the provisional table, the authentication ID (Auth_id) is not assigned to the provisional table entry #3 for the second terminal data from the user U#2.

Then, another user U#3 is assumed to transmit terminal data to the ASNS server 12.

The community generation unit 73 assigns a terminal ID (i_uid) to the user U#3 transmitting the terminal data, and registers an entry for the terminal data from the user U#3 in the provisional table.

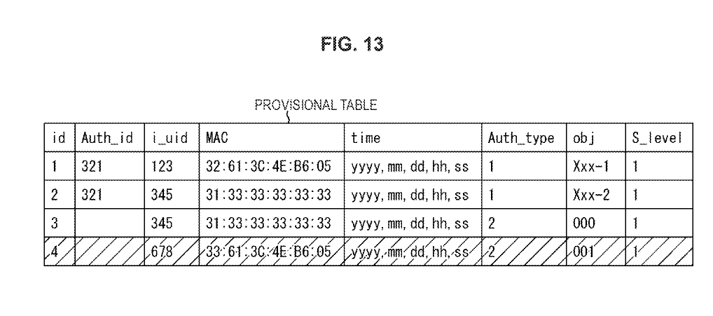

FIG. 13 is a diagram showing the provisional table in which the entry for the terminal data from the user U#3 is registered.

In FIG. 13, the entry having the provisional table ID (id) of 4 (a provisional table entry #4) for the terminal data from the user U#3 is registered in the provisional table.

Further, in FIG. 13, a terminal ID (i_uid) having a value 678 is assigned to the user U#3.

Further, in FIG. 13, since the user U#3 has transmitted the terminal data containing the common object of the voice, Auth_type of the provisional table entry #4 is 2, which is the value indicating the voice.

At this time, if the common object of the voice contained in the second terminal data from the user U#2 is similar to the common object of the voice contained in the terminal data from the user U#3, the community generation unit 73 regards the users U#2 and U#3 transmitting the similar common objects as being successful in authentication for participation in the community, and assigns the same authentication ID (Auth_id) to the provisional table entry #3 for the second terminal data from the user U#2 and the provisional table entry #4 for the terminal data from the user U#3, which contain the similar common object.

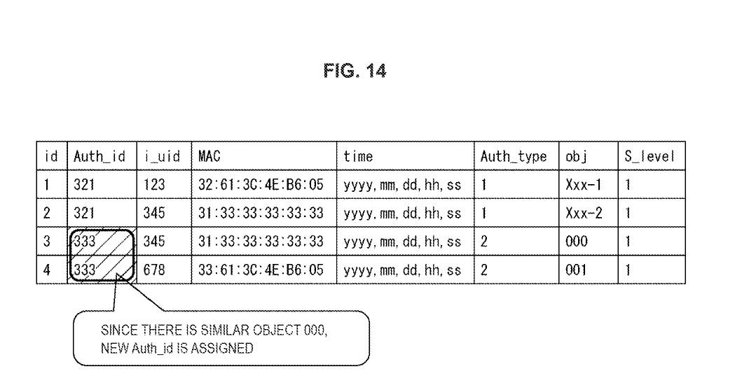

FIG. 14 is a diagram showing the provisional table after the same authentication ID has been assigned to the provisional table entries #3 and #4.

In FIG. 14, the authentication ID (Auth_id) having the value 333 different from the authentication ID of 321 assigned to the provisional table entries #1 and #2 is assigned to the provisional table entries #3 and #4.

Here, in FIG. 14, security levels (S_level) of the provisional table entries #1 to #4 all are level 1.

In the security level of level 1, common objects transmitted from (mobile terminals 11 of) a plurality of users participating in the community are permitted to be different types of objects, as described in FIG. 8.

Accordingly, in the security level of level 1, for example, the users U#1 to U#3 transmitting the different types of common objects, such as users U#1 and U#2 transmitting the terminal data containing the photograph as the common object and users U#2 and U#3 transmitting the terminal data containing the voice as the common object, can participate in the same community.

That is, when there is a user transmitting a plurality of common objects of different types among users transmitting terminal data with respect to the provisional table entries whose security level is level 1, the community generation unit 73 (FIG. 7) generates a community in which all users transmitting (terminal data containing) common objects similar to some of the plurality of common objects are permitted to participate.

In FIG. 14, the user U#2 of the users U#1 to U#3 transmitting the terminal data with respect to the provisional table entries #1 to #4 whose security level is level 1 transmits the common objects of the photograph and the voice as the plurality of common objects of different types.

Also, the common object of the photograph transmitted by the user U#1 is similar to the common object of the photograph transmitted by the user U#2, and the common object of the voice transmitted by the user U#3 is similar to the common object of the photograph transmitted by the user U#2.

In this case, the community generation unit 73 generates a community in which all the users U#1 to U#3 are permitted to participate.

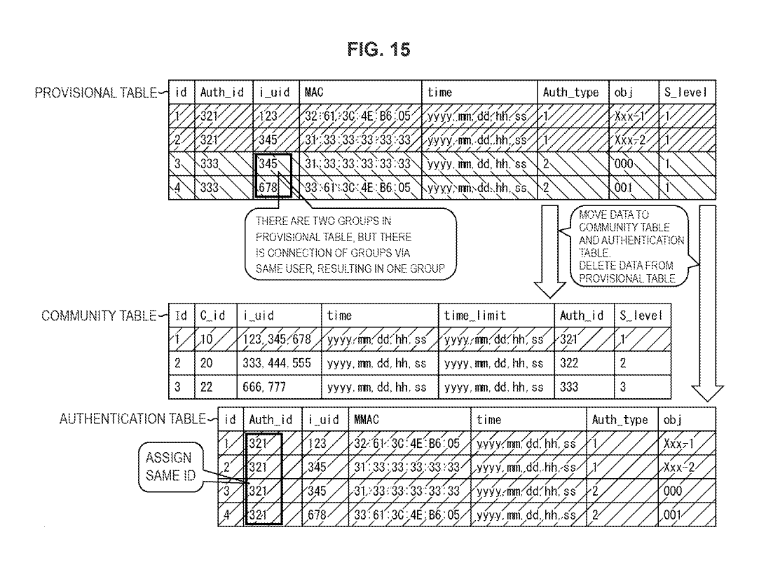

FIG. 15 is a diagram showing a provisional table, an authentication table, and a community table when a community in which users U#1 to U#3 are all permitted to participate is generated.

In FIG. 15, the same provisional table entries #1 to #4 as those in FIG. 14 are registered in the provisional table.

In the provisional table, an authentication ID having a value 321 is assigned to the provisional table entries #1 and #2, and an authentication ID having a value 333 is assigned to the provisional table entries #3 and #4, as described above. The authentication IDs assigned to the provisional table entries #1 and #2 are different from the authentication IDs assigned to the provisional table entries #3 and #4.

The community generation unit 73 registers entries corresponding to the provisional table entries to which the same authentication ID has been assigned, in the authentication table.

In FIG. 15, entries corresponding to the provisional table entries #1 and #2 to which the authentication ID having a value 321 has been assigned are registered in the authentication table.

Hereinafter, appropriately, an entry having the authentication table ID (id) of a value k registered in the authentication table is described as authentication table entry #k.

In FIG. 15, the authentication table entry #1 corresponds to the provisional table entry #1 (is the entry for the entry data of the provisional table entry #1), and the authentication table entry #2 corresponds to the provisional table entry #2.

The community generation unit 73 registers an authentication table entry corresponding to the respective provisional table entries #3 and #4 to which the authentication ID having a value 333 has been assigned, in the authentication table, but when the same terminal ID (i_uid) is registered in the provisional table entries to which different authentication IDs have been assigned, the community generation unit 73 registers authentication table entries corresponding to the provisional table entries to which different authentication IDs have been assigned, in the authentication table to have the authentication ID of the same value.

In FIG. 15, the same terminal ID (i_uid) of a value 345 is registered in the provisional table entry #2 among the provisional table entries #1 and #2 of the provisional table to which the authentication ID having the value 321 has been assigned, and the provisional table entry #3 among the provisional table entries #3 and #4 to which the authentication ID having the value 333 has been assigned.

In this case, the community generation unit 73 unifies authentication IDs of the provisional table entries to which the different authentication IDs have been assigned, that is, the provisional table entries #1 and #2 having the authentication ID (Auth_id) of the value 321 and the provisional table entries #3 and #4 having the authentication ID (Auth_id) of the value 333 into, for example, the value 321, which is the smallest value (a smaller value), and registers authentication table entries #1 to #4 corresponding to the provisional table entries #1 to #4 to which the unified authentication ID has been assigned, in the authentication table.

Further, the community generation unit 73 deletes the provisional table entries #1 to #4 corresponding to the authentication table entries #1 to #4 registered in the authentication table, from the provisional table.

As described with reference to FIG. 10, when there are entries to which the same authentication ID (Auth_id) has been assigned among the entries registered in the authentication table, the community generation unit 73 generates a community in which users (of the mobile terminals 11) specified by terminal IDs (i_uid) registered in the entries to which the same authentication ID has been assigned can participate.

That is, in FIG. 15, the authentication ID having the same value 321 is assigned to the authentication table entries #1 to #4, and the community generation unit 73 secures a storage area as a community in which the user U#1 specified by a value 123 that is the terminal ID (i_uid) registered in the authentication table entry #1, the user U#2 specified by a value 345 that is the terminal ID (i_uid) registered in the authentication table entries #2 and #3, and the user U#3 specified by a value 678 that is the terminal ID (i_uid) registered in the authentication table entry #4 can participate.

Further, the community generation unit 73 registers entries corresponding to the authentication table entries #1 to #4 to which the authentication ID having the same value 321 has been assigned, in the community table.

That is, the community generation unit 73 assigns a community ID (C_id) to a community in which the users U#1 to U#3 to which the authentication ID having the same value 321 has been assigned (the users U#1 to U#3 specified by the terminal ID (i_uid) registered in the authentication table entries #1 to #4 to which the authentication ID having the same value 321 has been assigned) can participate, and registers entries of community data containing the community ID (C_id) or the terminal IDs (i_uid) of the users U#1 to U#3 that can participate in the community, in the community table.

Hereinafter, appropriately, an entry having the community table ID (id) of a value k registered in the community table is described as a community table entry #k.

In FIG. 15, a community table entry #1 to which a community ID (C_id) having a value 10 is assigned and which contains values 123, 345 and 678, which are the terminal IDs of the users U#1 to U#3, is registered in the community table as a community table entry corresponding to the authentication table entries #1 to #4 to which the authentication ID having the same value 321 has been assigned, that is, a community table entry for managing the community in which the users U#1 to U#3 can participate.

The community processing unit 74 permits only (the mobile terminals 11 of) the users U#1 to U#3 whose terminal IDs (i_uid) of 123, 345, and 678 are registered in the community table entry #1 to access the community specified by the community ID (C_id) of 10 registered in the community table entry #1, by referencing the community table entry #1.

As described above, in the security level of level 1, the users U#1 to U#3 transmitting different types of common objects, that is, the users U#1 and U#2 transmitting the terminal data containing the photograph as the common object and the users U#2 and U#3 transmitting the terminal data containing the voice as the common object can all participate in the same community.

Here, for example, when the users U#1 to U#3 gather at a certain place and, in order to generate a community, the user U#1 transmits terminal data containing, as the common object, a photograph of a landscape of the gathering place photographed by a camera to the ASNS server 12 using, for example, a mobile phone with the camera as the mobile terminal 11, the user U#2 transmits terminal data containing, as the common object, a photograph of a landscape of the gathering place photographed by a camera to the ASNS server 12 using, for example, a mobile phone with the camera as the mobile terminal 11 and then transmits terminal data containing, as the common object, voice obtained by uttering a predetermined word to the ASNS server 12, and the user U#3 transmits terminal data containing, as the common object, voice obtained by uttering a predetermined word to the ASNS server 12 using, for example, a mobile phone without a camera as the mobile terminal 11, the community in which the users U#1 to U#3 can participate is generated, as described in FIGS. 11 to 15.

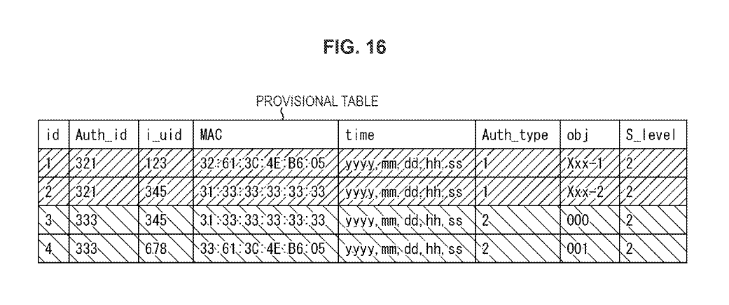

FIG. 16 is a diagram showing a provisional table.

The provisional table entries #1 to #4, like those of the provisional table of FIG. 14, are registered in the provisional table of FIG. 16.

Accordingly, authentication IDs (Auth_id) of the provisional table entries #1 and #2 are different from authentication IDs (Auth_id) of the provisional table entries #3 and #4. The authentication IDs (Auth_id) of the provisional table entries #1 and #2 have values 321, and the authentication IDs (Auth_id) of the provisional table entries #3 and #4 have values 333.

However, in FIG. 14, security levels (S_level) of the provisional table entries #1 to #4 are all level 1 while in FIG. 16, security levels (S_level) of the provisional table entries #1 to #4 are all level 2.

In the security level of level 2, it is necessary for common objects transmitted from the respective mobile terminals 11 of a plurality of users participating in the community to be the same types of objects, as described in FIG. 8.

Accordingly, in the security level of level 2, for example, it is difficult for users transmitting different types of common objects, such as a user transmitting the terminal data containing a photograph as a common object and a user transmitting the terminal data containing sound as the common object, to participate in the same community.

That is, when there is a user transmitting a plurality of common objects of different types among the users transmitting the terminal data for the provisional table entries whose security level is level 2, the community generation unit 73 (FIG. 7) counts, for the plurality of common objects, the terminal number of mobile terminals 11 transmitting a common object similar to such a common object (hereinafter also referred to as the user number since the terminal number is the user number of the users of the mobile terminals 11), and generates a community in which the user (of the mobile terminal 11) transmitting a common object similar to the common object whose user number is greatest by a majority decision based on the user number are permitted to participate.

In FIG. 16, among the user U#1 to U#3 transmitting the terminal data for the provisional table entries #1 to #4 whose security level is level 2, the user U#2 transmits the common objects of the photograph and the voice as the plurality of common objects of different types.

In this case, the community generation unit 73 counts the user number of users (of mobile terminals 11) transmitting a common object similar to the common objects of the photograph and the voice that are the plurality of common objects transmitted by the user U#2.

In FIG. 16, the common object of the photograph transmitted by the user U#1 is similar to the common object of the photograph transmitted by the user U#2, and the common object of the voice transmitted by the user U#3 is similar to the common object of the photograph transmitted by the user U#2.

Accordingly, in FIG. 16, the user transmitting the common object similar to the common object of the photograph transmitted by the user U#2 is only the user U#1, and the user transmitting the common object similar to the common object of the voice transmitted by the user U#2 is only the user U#3. Accordingly, since a winner is difficult to determine by the majority decision, the community generation unit 73 does not generate the community at this stage.

Then, a user U#4 is assumed to transmit terminal data to the ASNS server 12, in addition to the users U#1 to U#3.

The community generation unit 73 assigns a terminal ID (i_uid) to the user U#4 transmitting the terminal data, and registers an entry for the terminal data from the user U#4 in the provisional table.

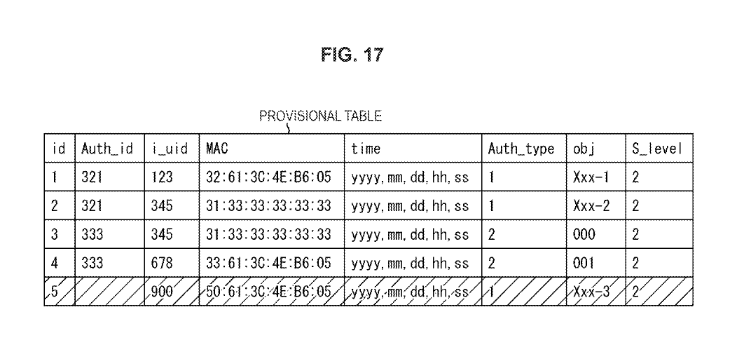

FIG. 17 is a diagram showing the provisional table in which the entry for the terminal data from user U#4 has been registered.

In FIG. 17, the entry whose provisional table ID (id) is 5 (provisional table entry #5) is registered for the terminal data from the user U#4 in the provisional table.

Further, in FIG. 17, the terminal ID (i_uid) whose value is 900 is assigned to the user U#4.

Further, in FIG. 17, since the user U#4 has transmitted the terminal data containing a common object of a photograph, Auth_type of the provisional table entry #5 is 1, which is the value indicating the photograph.

Further, a security level (S_level) of the provisional table entry #5 is the same level 2 as those of the other provisional table entries #1 to #4.

Now, if the common object of the photograph contained in the terminal data from the user U#4 is similar to the common object of the photograph contained in the terminal data from the user U#1 or the user U#2, the community generation unit 73 regards authentication for participation in the community of the user U#4 transmitting the similar common object as successful, and assigns, to the provisional table entry #5 for the terminal data from user U#4, the same authentication ID (Auth_id) as the provisional table entry #1 or #2 in which the common object of the photograph similar to the common object of the photograph contained in the terminal data from the user U#4 has been registered.

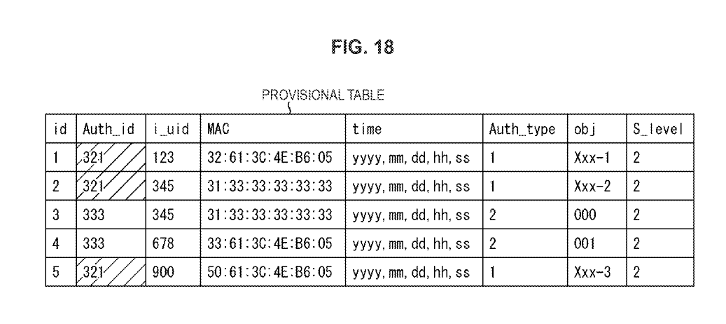

FIG. 18 is a diagram showing the provisional table after the same authentication ID as those of the provisional table entries #1 and #2 has been assigned to the provisional table entry #5

In FIG. 18, the same authentication ID as those of the provisional table entries #1 and #2 is assigned to the provisional table entry #5, and, as a result, the authentication IDs of the provisional table entries #1, #2 and #5 have the value 321 and the authentication IDs of the provisional table entries #3 and #4 have the value 333.

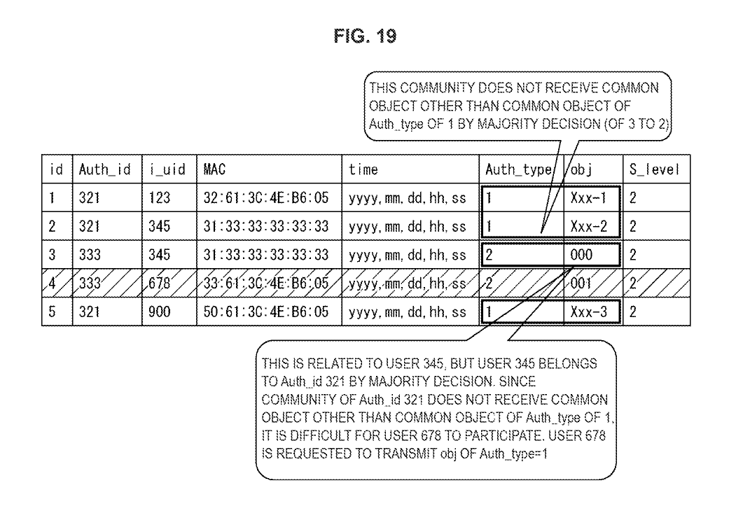

FIG. 19 is a diagram illustrating generation of the community by a majority decision based on the number of users.

That is, FIG. 19 shows a provisional table in which the same provisional table entries #1 to #5 as those in FIG. 18 are registered.

In FIG. 19, since users transmitting common objects similar to a common object of a photograph among a plurality of common objects of a user U#2 (a user having i_uid 345), who transmits common objects of the photograph and a voice as the plurality of common objects, are two persons, users U#1 and U#4 (a user having i_uid 123 and a user having i_uid 900), and a user transmitting a common object similar to the common object of the voice of the user U#2 is one person, a user U#3 (a user having i_uid 678), a majority decision between the users transmitting the common object of the photograph and the users transmitting the common object of the voice is 3:2, including the user U#2.

Accordingly, since the common object of the photograph among the common objects of the photograph and the voice as the plurality of common objects transmitted by the user U#2 has a greater number of users than the common object of the voice, the community generation unit 73 generates a community in which the users transmitting the common object of the photograph having the greater number of users are permitted to participate.

That is, the object generation unit 73 registers authentication table entries corresponding to the provisional table entry #1 for the terminal data from the user U#1, the provisional table entry #2 for the first terminal data from the user U#2, and the provisional table entry #5 for the terminal data from the user U#4, which contain the common object of the photograph that is a winner of the majority decision of the user number, (the provisional table entries to which the authentication ID having a value 321 (Auth_id) has been assigned in FIG. 19), in the authentication table, and generates a community in which the users U#1, U#2 and U#4 transmitting the common object of the photograph, which is the winner of the majority decision, are permitted to participate (the users U#1, U#2 and U#4 can participate), as described in FIG. 15.

It is difficult for a user that does not transmit the common object of the photograph (a common object having Auth_type of a value 1) that is the winner of the majority decision, that is, the user #3 transmitting only the common object of the voice (the common object having Auth_type of a value 2) that is not the winner of the majority decision (the user #3 transmitting the terminal data for the provisional table entry #4) to participate in the community in which the users U#1,U#2 and U#4 can participate.

In order to participate in the community in which the user U#1, U#2 and U#4 can participate, it is necessary for the user #3 to transmit (the common object of the photograph similar to) the common object of the photograph that is the winner of the majority decision, to the ASNS server 12.

Accordingly, the community generation unit 73 may cause the communication unit 61 (FIG. 6) to transmit a message to request the user #3 transmitting only the common object of the voice that is not the winner of the majority decision (the common object having Auth_type of value 2) to transmit the common object of the photograph that is the winner of the majority decision (the common object having Auth_type of value 1).

As described above, when a plurality of common objects of different types are transmitted from one mobile terminal 11, the ASNS server 12 counts, for the plurality of common objects, the terminal number (user number) of mobile terminals 11 transmitting a common object similar to such a common object, and generates a community in which the user of the mobile terminal 11 transmitting the common object similar to the common object whose terminal number is greatest are permitted to participate. That is, when a plurality of types of common objects are received, the ASNS server 12 generates a community in which the users transmitting similar common objects whose number is greatest are permitted to participate. Thus, it is possible to easily generate a highly convenient community.

That is, it is possible to easily generate the community in which a common object for authentication for participation in the community can be determined by the majority decision of users desiring to generate the community.

Further, since the ASNS server 12 generates the community based on the security level, the user can generate, for example, a community in which a user transmitting a common object similar to any of a plurality of (types) of common objects is permitted to participate or can easily generate a community in which (a type of) a common object for authentication for participation in the community can be determined by the majority decision, as described above, only with designation of the security level.

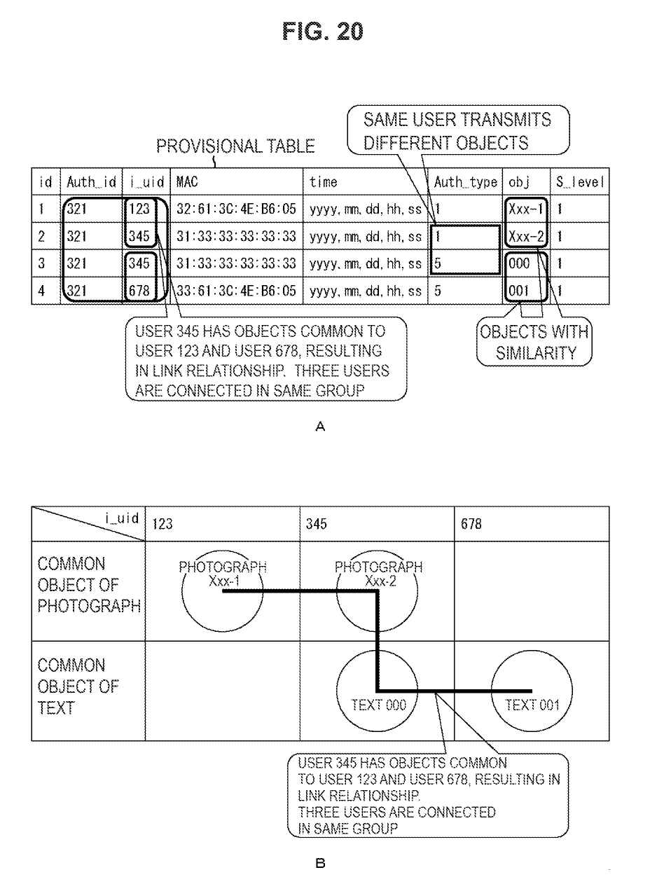

FIG. 20 is a diagram illustrating generation of the community in the community generation unit 73 (FIG. 7) when the security level (S_level) is level 1.

Hereinafter, appropriately, a user (of a mobile terminal 11) to which a value k has been assigned as a terminal ID (i_uid) is hereinafter described as a user i_uid #k.

FIG. 20A shows a provisional table.

A provisional table entry #1 for terminal data containing a common object Xxx-1 transmitted by a user i_uid #123, a provisional table entry #2 for terminal data containing a common object Xxx-2 transmitted by a user i_uid #345, a provisional table entry #3 for terminal data containing a common object 000 transmitted by the user i_uid #345, and a provisional table entry #4 for terminal data containing a common object 001 transmitted by a user i_uid #678 are registered in the provisional table of FIG. 20A.

Accordingly, in FIG. 20, the user i_uid #345 transmits the two common objects Xxx-2 and 000.

Further, in the provisional table of FIG. 20A, both Auth_type of the provisional table entry #1 containing the common object Xxx-1 and Auth_type of the provisional table entry #2 containing the common object Xxx-2 are values 1 indicating a photograph. Both Auth_type of the provisional table entry #3 containing the common object 000 and Auth_type of the provisional table entry #4 containing the common object 001 both are values 5 indicating text.

Accordingly, the common objects Xxx-1 and Xxx-2 are (objects of) the photographs and the common objects 000 and 001 are the text.

Further, the common objects Xxx-1 and Xxx-2 are similar to each other, and the common objects 000 and 001 are similar to each other.

In FIG. 20A, security levels (S_level) of the provisional table entries #1 to #4 are level 1.

Further, in FIG. 20A, the user i_uid #345 transmits the two common objects Xxx-2 and 000, that is, the common object Xxx-2 of the photograph and the common object 000 of the text.

Also, the common object Xxx-1 of the photograph from the user i_uid #123 is similar to the common object Xxx-2 of the photograph from the user i_uid #345 who transmits the two common objects Xxx-2 and 000, and the common object 001 of the text from the user i_uid #678 is similar to the common object 000 of the text from the user i_uid #345 who transmits the two common objects Xxx-2 and 000.

In this case, in the security level of level 1, a community in which the users i_uid #123, i_uid #345 and i_uid #678 are permitted to participate is generated, as described in FIG. 15.

FIG. 20B is a diagram illustrating the users who can participate in the community generated in the security level of level 1.

For example, the user i_uid #123 transmits the common object Xxx-1 of the photograph to the ASNS server 12, and the user i_uid #345 transmits the two types of common objects of the common object Xxx-2 of the photograph similar to the common object Xxx-1 and the common object 000 of the text to the ASNS server 12.

Further, for example, the user i_uid #678 transmits the common object 001 of the text similar to the common object 000 to the ASNS server 12.

In this case, since the common object Xxx-1 of the photograph of the user i_uid #123 and the common object 001 of the text of the user i_uid #678 have different types (media), they are not similar to each other.

Accordingly, in the ASNS server 12, a community in which the users i_uid #123 and i_uid #678 can participate is not generated only with the common object Xxx-1 of the photograph of the user i_uid #123 and the common object 001 of the text of the user i_uid #678.

However, in FIG. 20, the user i_uid #345 transmits the two types of common objects of the common object Xxx-2 of the photograph similar to the common object Xxx-1 of the photograph of the user i_uid #123 and the common object 000 of the text similar to the common object 001 of the text of the user i_uid #678 to the ASNS server 12.

In this case, in the ASNS server 12, the users i_uid #123 and i_uid #345 transmitting the similar common objects of the photographs are linked (grouped into one group) (assigned the same authentication ID), as shown in FIG. 20B.

Further, in the ASNS server 12, the users i_uid #345 and i_uid #678 transmitting the similar common objects of the text are linked, as shown in FIG. 20B.

Also, in the security level of level 1, the user i_uid #123 transmitting the common object of the photograph and the user i_uid #678 transmitting the common object of the text are linked via the user i_uid #345 who is a common link destination, as shown in FIG. 20B.

As described above, all the users i_uid #123, i_uid #345 and i_uid #678 are linked, and the community in which the users i_uid #123, i_uid #345 and i_uid #678 can participate is generated in the ASNS server 12.

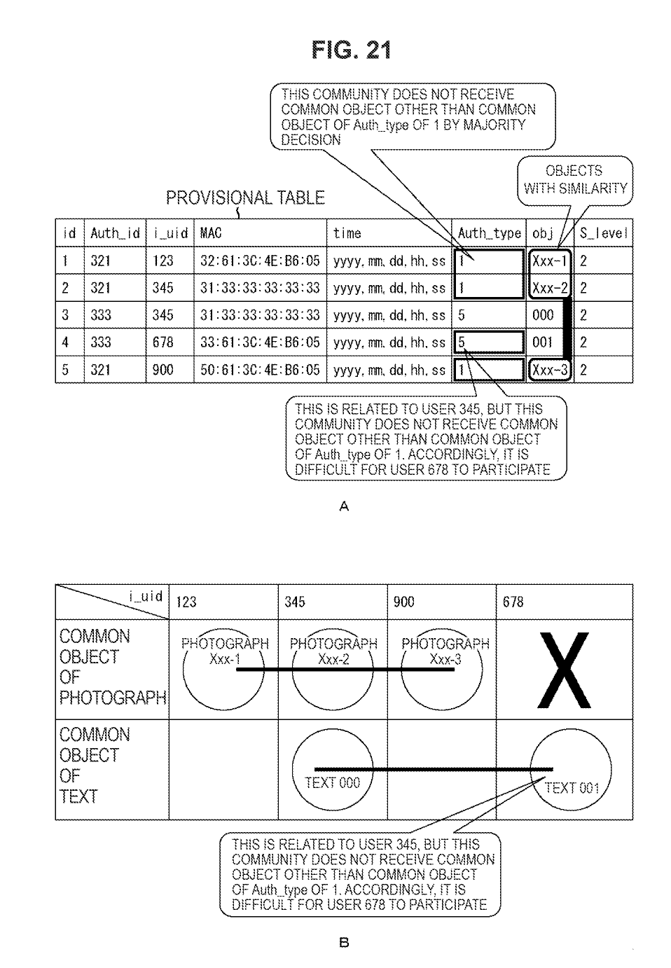

FIG. 21 is a diagram illustrating generation of the community in the community generation unit 73 (FIG. 7) when the security level (S_level) is level 2.

FIG. 21A shows the provisional table.

A provisional table entry #1 for terminal data containing a common object Xxx-1 transmitted by a user i_uid #123, a provisional table entry #2 for terminal data containing a common object Xxx-2 transmitted by a user i_uid #345, a provisional table entry #3 for terminal data containing a common object 000 transmitted by a user i_uid #345, a provisional table entry #4 for terminal data containing a common object 001 transmitted by a user i_uid #678, and a provisional table entry #5 for terminal data containing a common object Xxx-3 transmitted by a user i_uid #900 are registered in the provisional table of FIG. 21A.

In FIG. 21, the user i_uid #345 transmits the two common objects Xxx-2 and 000, as in FIG. 20.

Further, in the provisional table of FIG. 21A, Auth_type of the provisional table entry #1 containing the common object Xxx-1, Auth_type of the provisional table entry #2 containing the common object Xxx-2 and Auth_type of the provisional table entry #5 containing the common object Xxx-3 all have a value 1 indicating a photograph. Auth_type of the provisional table entry #3 containing the common object 000 and Auth_type of the provisional table entry #4 containing the common object 001 both have a value 5 indicating text.

Thus, the common objects Xxx-1, Xxx-2 and Xxx-3 are photographs, and the common object 000 and 001 are text.

Further, the common objects Xxx-1, Xxx-2 and Xxx-3 are assumed to be similar to one another and the common objects 000 and 001 are assumed to be similar to each other.

In FIG. 21A, the security levels (S_level) of the provisional table entries #1 to #5 are level 2.

Further, in FIG. 21A, the user i_uid #345 transmits the two common objects Xxx-2 and 000, that is, the common object Xxx-2 of the photograph and the common object 000 of the text.

Also, the common object Xxx-1 of the photograph from the user i_uid #123 is similar to the common object Xxx-2 of the photograph from the user i_uid #345 who transmits the two common objects Xxx-2 and 000.

Further, the common object Xxx-3 of the photograph from the user i_uid #900 is similar to the common object Xxx-2 of the photograph from the user i_uid #345 who transmits the two common objects Xxx-2 and 000.

Further, the common object 001 of the text from the user i_uid #678 is similar to the common object 000 of the text from the user i_uid #345 who transmits the two common objects Xxx-2 and 000.

Accordingly, the two common objects of the common object Xxx-1 of the photograph from the user i_uid #123 and the common object Xxx-3 of the photograph from the user i_uid #900 are similar to the common object Xxx-2 of the photograph from the user i_uid #345 who transmits the two common objects Xxx-2 and 000.

Further, only one common object, which is the common object 001 of the text from the user i_uid #678, is similar to the common object 000 of the text from the user i_uid #345 who transmits the two common objects Xxx-2 and 000.

In this case, among the common object Xxx-2 of the photograph and the common object 000 of the text from the user i_uid #345 who transmits the two common objects Xxx-2 and 000, the common object Xxx-2 of the photograph has a greater number of similar common objects. Accordingly, a community in which the users i_uid #123, i_uid #345 and i_uid #900 transmitting the similar photograph objects are permitted to participate by a majority decision as described in FIGS. 17 to 19 is generated in the security level of level 2.

FIG. 21B is a diagram illustrating users that can participate in the community generated in the security level of level 2.

For example, the user i_uid #123 transmits the common object Xxx-1 of the photograph to the ASNS server 12, and the user i_uid #345 transmits the two types of common objects of the common object Xxx-2 of the photograph similar to the common object Xxx-1 and the common object 000 of the text to the ASNS server 12.

Further, for example, the user i_uid #678 transmits the common object 001 of the text similar to the common object 000 to the ASNS server 12, and the user i_uid #900 transmits the common object Xxx-3 of the photograph similar to the common object Xxx-1 to the ASNS server 12.

In this case, a community in which the users i_uid #123, i_uid #345 and i_uid #900 transmitting the common objects of the photographs having a greater number of similar common objects by a majority decision can participate is generated in the ASNS server 12.

That is, in the security level of level 2, the users i_uid #123, i_uid #345 and i_uid #900 transmitting the similar common objects of the photographs are linked as shown in FIG. 21B.

Further, the users i_uid #345 and i_uid #678 transmitting the similar common objects of the text are linked as shown in FIG. 21B.

However, in the security level of level 2, the user i_uid #123 or i_uid #900 transmitting only the common object of the photograph and the user i_uid #678 transmitting only the common object of the text are not linked via the user i_uid #345 even when there is the user i_uid #345 that is a common link destination, as shown in FIG. 21B.

Also, in the ASNS server 12, the community in which the users i_uid #123, i_uid #345 and i_uid #900 whose number of links is great can participate is generated.

In this case, it is difficult for the user i_uid #678 transmitting only the common object 001 of the text to participate in the community in which the users i_uid #123, i_uid #345 and i_uid #678 can participate, unless the user i_uid #678 transmits a common object of a photograph similar to the common objects Xxx-1, Xxx-2 or Xxx-3 of the photographs.

As described above, in the security level of level 2, participation of a user who does not transmit the common object of the type that is the winner of the majority decision (the common object of the photograph in FIG. 21), in the community in which the users transmitting the common object of the type that is the winner can participate, is limited.

### [Provisional Table Registration Process]

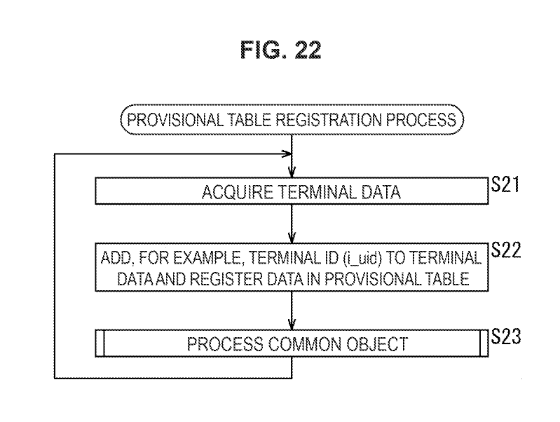

FIG. 22 is a flowchart illustrating a provisional table registration process in which the ASNS server 12 (FIG. 6) registers provisional table entries in the provisional table.

In the ASNS server 12, the communication unit 61 waits for the terminal data to be received from the mobile terminal 11 and, in step S21, receives and acquires the terminal data from the mobile terminal 11, and supplies the terminal data to the community generation unit 73 of the community management unit 62 (FIG. 7). The process proceeds to step S22.

In step S22, the community generation unit 73 assigns a terminal ID (i_uid) to the user (of the mobile terminal 11) transmitting the terminal data received in the immediately previous step S21, generates the entry data from the terminal ID and the terminal data, and registers the entry data in the provisional table entry of the provisional table (FIG. 8). The process proceeds to step S23.

In step S23, the common object processing unit 72 performs common object processing to process the common objects registered in the provisional table entries of the provisional table (the common objects contained in the terminal data from the user).

Also, the ASNS server 12 waits for the terminal data to be received from the mobile terminal 11, and the process returns from step S23 to step S21. The same process is subsequently repeated.

### [Common Object Processing]

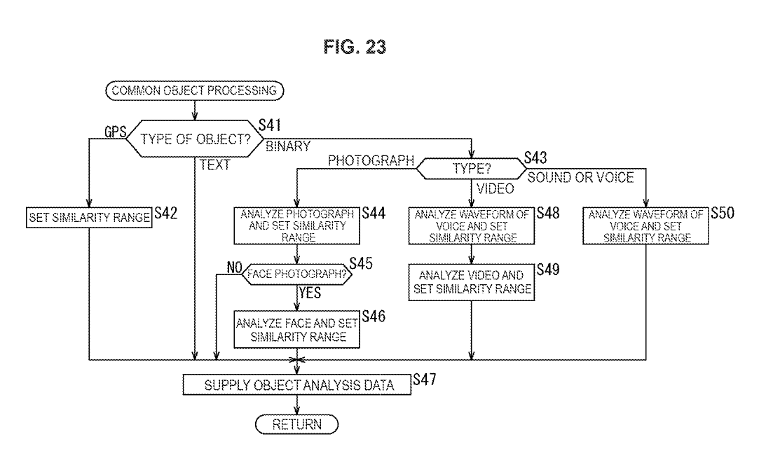

FIG. 23 is a flowchart illustrating the common object processing performed in step S23 of FIG. 22.

In step S41, the common object processing unit 72 determines whether the type of the common object (obj) of the latest provisional table entry of the provisional table (FIG. 8) is position information based on GPS, text, or binary data by referencing Auth_type of the latest provisional table entry.

If it is determined in step 41 that the type of the common object (obj) of the latest provisional table entry is the text, the processing proceeds to step S47 in which the common object processing unit 72 supplies the text that is the common object (obj) of the latest provisional table entry to the community generation unit 73 as object analysis data used for a similarity determination as to whether the common objects are similar, and the processing returns.

Further, if it is determined in step S41 that the type of the common object (obj) of the latest provisional table entry is the position information of GPS, the processing proceeds to step S42 in which the common object processing unit 72 sets a similarity range that is a threshold of the similarity determination within which the position information that is the common object (obj) of the latest provisional table entry can be said to be similar to position information that is another common object, and the processing proceeds to step S47.

In this case, in step S47, the common object processing unit 72 supplies the position information that is the common object (obj) of the latest provisional table entry to the community generation unit 73 as object analysis data used for the similarity determination as to whether the common objects are similar, and supplies the similarity range set in step S42 to the community generation unit 73. Then, the processing returns.

Here, the community generation unit 73 (FIG. 7) performs the similarity determination as to whether the common objects are similar to each other, as will be described afterward. The similarity determination as to whether the common objects are similar is made, for example, based on whether the distance between the common objects (corresponding to a reciprocal of the similarity degree described with reference to FIG. 2) is within the predetermined threshold.

That is, if the distance between the common objects is within the predetermined threshold, the common objects are determined to be similar to each other, and if the distance between the common objects is not within the predetermined threshold, the common objects are determined not to be similar to each other.

Data used to obtain the distance between the common objects is object analysis data. When the common object is, for example, latitude and longitude that is position information of GPS, the distance can be obtained using the latitude and the longitude, and accordingly the latitude and the longitude that are the position information are used as the object analysis data as is.

Further, if the distance between the common objects is within the predetermined threshold in the similarity determination, the common objects are determined to be similar to each other as described above, but the predetermined threshold is a similarity range, and a similarity range that is the threshold used for the similarity determination between the common objects of the position information is set in step S42.

Further, when the text matches in each letter and each clause in the similarity determination between the common objects of the text, the common objects of the text are determined to be similar to each other. Accordingly, since, in the similarity determination between the common objects of the text, each letter of the text is used as object analysis data to calculate the distance and the similarity range is not present (is 0), if it is determined in step S41 that the type of the common object (obj) of the latest provisional table entry is the text, it is difficult (and unnecessary) to obtain either the object analysis data or the similarity range for the common object of such a text.

Here, when the similarity range is set, for example, a previously determined value may be set as the similarity range for each type of common object (for each object analysis data used to obtain the distance).

If it is determined in step S41 that the type of the common object (obj) of the latest provisional table entry is the binary data, the processing proceeds to step S43 in which the common object processing unit 72 determines whether the binary data that is the common object (obj) of the latest provisional table entry is a photograph, a video or voice (sound).

If it is determined in step S43 that binary data that is the common object (obj) of the latest provisional table entry is the photograph, the processing proceeds to step S44 in which the common object processing unit 72 analyzes the photograph that is the common object (obj) of the latest provisional table entry to obtain a feature quantity (vector) of an image as the photograph, as object analysis data, and sets a similarity range used for a similarity determination for the photograph. The processing proceeds to step S45.

In step S45, the common object processing unit 72 determines whether the photograph that is the common object (obj) of the latest provisional table entry is a face photograph including a face of a person.

If it is determined in step S45 that the photograph that is the common object (obj) of the latest provisional table entry is not the face photograph, the processing skips step S46 and proceeds to step S47 in which the common object processing unit 72 supplies the object analysis data and the similarity range obtained in the immediately previous step S44 to the community generation unit 73. Then, the processing returns.

Further, if it is determined in step S45 that the photograph that is the common object (obj) of the latest provisional table entry is the face photograph, the processing proceeds to step S46 in which the common object processing unit 72 analyzes the face photograph that is the common object (obj) of the latest provisional table entry using a method of obtaining a feature quantity of the face, to thereby obtain a feature quantity of an image as the face photograph, as object analysis data and sets a similarity range used for a similarity determination for the face photograph. The processing proceeds to step S47.

In this case, in step S47, the common object processing unit 72 supplies the object analysis data and the similarity range obtained in the immediately previous step S46 to the community generation unit 73. The, the common object processing returns.

Meanwhile, if it is determined in step S43 that the binary data that is the common object (obj) of the latest provisional table entry is the video, the processing proceeds to step S48 in which the common object processing unit 72 analyzes a waveform of voice (sound) with which the video that is the common object (obj) of the latest provisional table entry is accompanied, to thereby acquire a feature quantity (vector) of the voice as the object analysis data, and sets the similarity range used for a similarity determination for the voice. The processing proceeds to step S49.

In step S49, the common object processing unit 72 analyzes an image as the video that is the common object (obj) of the latest provisional table entry to obtain a feature quantity of the image as the object analysis data, and sets a similarity range used for the similarity determination for the image. The processing proceeds to step S47.

In this case, in step S47, the common object processing unit 72 supplies the object analysis data and the similarity range for the voice with which the video is accompanied, obtained in the immediately previous step S48, and the object analysis data and the similarity range for the image as the video, obtained in the immediately previous step S49, to the community generation unit 73. Then, the processing returns.

Here, the videos are determined to be similar in the similarity determination between the common objects of videos when a distance between object analysis data (a distance obtained from the object analysis data) for the voice with which the video is accompanied is equal to or less than a similarity range for voice (within the similarity range) and a distance between object analysis data for the images as the videos is equal to or less than the similarity range for an image.

If it is determined in step S43 that the binary data that is the common object (obj) of the latest provisional table entry is voice (sound), the processing proceeds to step S50 in which the common object processing unit 72 analyzes a waveform of voice that is the common object (obj) of the latest provisional table entry to obtain a feature quantity of the voice as the object analysis data, and sets the similarity range used for similarity determination for voice. The processing proceeds to step S47.

In this case, in step S47, the common object processing unit 72 supplies the object analysis data and the similarity range for voice, obtained in the immediately previous step S50, to the community generation unit 73, and the common object processing returns.

### [Authentication ID Assignment Process]

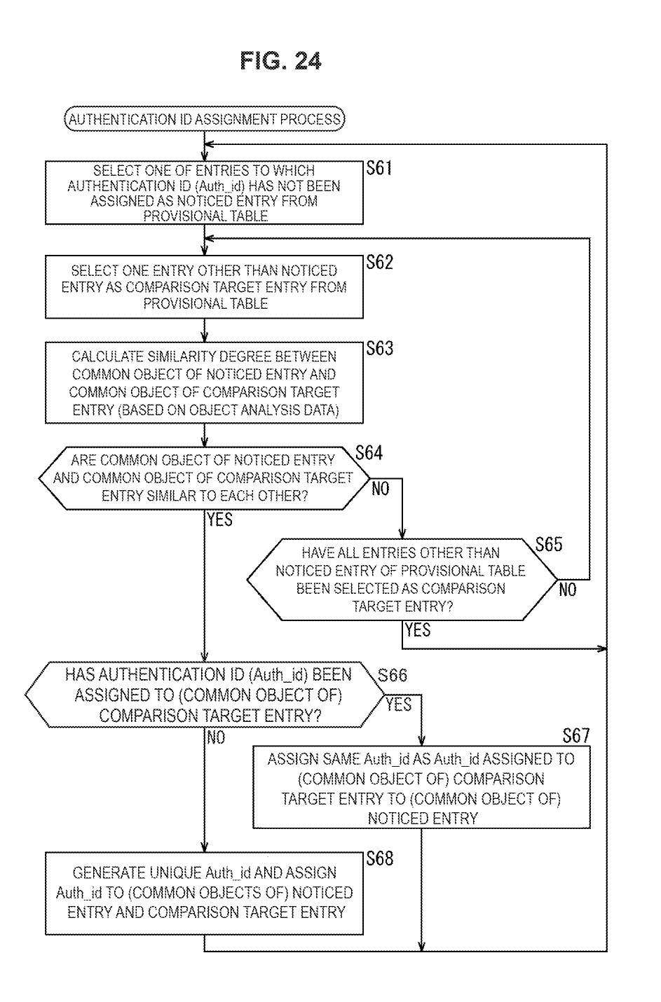

FIG. 24 is a flowchart illustrating an authentication ID assignment process in which the community generation unit 73 (FIG. 7) assigns an authentication ID (Auth_id) to an entry to which the authentication ID (Auth_id) has not been assigned among the entries of the provisional table.

In step S61, the community generation unit 73 selects an entry to which the authentication ID (Auth_id) has not been assigned, as a noticed entry, from the provisional table (FIG. 8) and the process proceeds to step S62.

In step S62, the community generation unit 73 selects an entry other than the noticed entry, that is, one of entries not yet selected as a comparison target entry with respect to the noticed entry from the provisional table (FIG. 8), as a comparison target entry, which is a comparison target to be compared in common object with the noticed entry, and the process proceeds to step S63.

In step S63, the community generation unit 73 calculates a distance as a similarity degree between the common object of the noticed entry and the common object of the comparison target entry, using object analysis data acquired from the common object of the noticed entry and object analysis data acquired from the common object of the comparison target entry, and the process proceeds to step S64.

In step S64, the community generation unit 73 determines whether the common object of the noticed entry is similar to the common object of the comparison target entry based on the distance as the similarity degree between the common object of the noticed entry and the common object of the comparison target entry.

If it is determined in step S64 that the common object of the noticed entry is not similar to the common object of the comparison target entry, the process proceeds to step S65 in which the community generation unit 73 determines whether all entries other than the noticed entry of the provisional table have been selected as the comparison target entry.

If it is determined in step S65 that there is an entry not yet selected as the comparison target entry among the entries other than the noticed entry of the provisional table, the process returns to step S62. The same process is subsequently repeated.

Further, if it is determined in step S65 that all the entries other than the noticed entry of the provisional table have been selected as the comparison target entry, the process returns to step S61. The same process is subsequently repeated.

Meanwhile, if it is determined in step S64 that the common object of the noticed entry is similar to the common object of the comparison target entry, that is, the distance of the similarity degree between the common object of the noticed entry and the common object of the comparison target entry is equal to or less than the similarity range (FIG. 23) set for the common object of the noticed entry, the process proceeds to step S66 in which the community generation unit 73 determines whether the authentication ID (Auth_id) has already been assigned to the comparison target entry of the provisional table (FIG. 8).

If it is determined in step S66 that the authentication ID (Auth_id) has already been assigned to the comparison target entry, the process proceeds to step S67 in which the community generation unit 73 assigns the same authentication ID (Auth_id) as the authentication ID (Auth_id) assigned to the comparison target entry to the noticed entry of the provisional table. The process returns to step S61.

Further, if it is determined in step S66 that the authentication ID (Auth_id) has not been assigned to the comparison target entry, the process proceeds to step S68 in which the community generation unit 73 generates (issues) a unique authentication ID (Auth_id) not present in the provisional table, and assigns the authentication ID (Auth_id) to the noticed entry and the comparison target entry of the provisional table. Then, the process returns to step S61.

As described above, in the authentication ID assignment process, when there is, in the provisional table, another entry similar in the common object to the entry to which the authentication ID (Auth_id) has not been assigned, the authentication ID (Auth_id) is assigned to the entry to which the authentication ID (Auth_id) has not been assigned.

In assigning the authentication ID (Auth_id), when the authentication ID (Auth_id) has already been assigned to the other entry similar in the common object to the entry to which the authentication ID (Auth_id) has not been assigned, the same authentication ID (Auth_id) as such an authentication ID (Auth_id) is assigned to the entry to which the authentication ID (Auth_id) has not been assigned.

Meanwhile, when the authentication ID (Auth_id) has not yet been assigned to the other entry similar in common object to the entry to which the authentication ID (Auth_id) has not been assigned, a newly issued unique authentication ID (Auth_id) is assigned to the entry to which the authentication ID (Auth_id) has not been assigned and the other entry similar in common object to such an entry.

### [Community Generation Process]

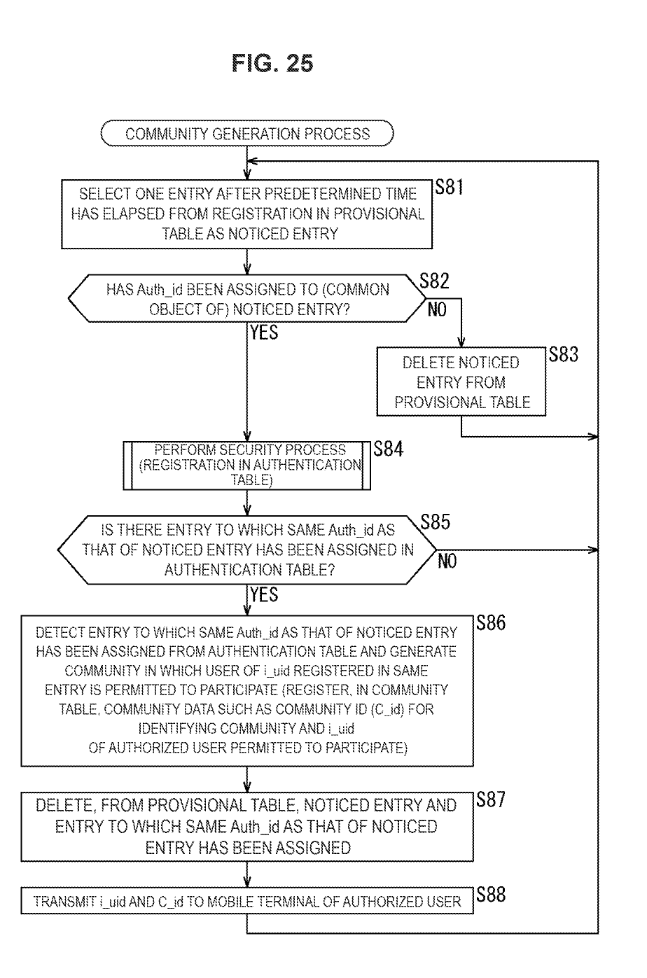

FIG. 25 is a flowchart illustrating a community generation process in which the community generation unit 73 (FIG. 7) generates a community by referencing the provisional table.

In step S81, the community generation unit 73 selects one entry after a predetermined time (or more) has elapsed from the registration in the provisional table (FIG. 8), as the noticed entry, and the process proceeds to step S82.

In step S82, the community generation unit 73 determines whether an authentication ID (Auth_id) has been assigned to the noticed entry.

If it is determined in step S82 that the authentication ID (Auth_id) has not been assigned to the noticed entry, the process proceeds to step S83 in which the community generation unit 73 deletes the noticed entry from the provisional table. Then, the process returns to step S81.

In this case, since the noticed entry is an entry after at least a predetermined time has elapsed from the registration in the provisional table, the fact that the authentication ID (Auth_id), which is assigned to the noticed entry through the authentication ID assignment process (FIG. 24), has not been assigned shows a high probability that (terminal data containing) a common object similar to the common object of the noticed entry is not transmitted to the ASNS server 12 and there is no other user desiring to participate in a community in which the other user can participate together with the user transmitting the common object of the noticed entry for a predetermined time before and after a time when the noticed entry has been registered in the provisional table.

When the authentication ID (Auth_id) has not been assigned to the noticed entry, the community generation unit 73 deletes the noticed entry from the provisional table in step S83, as described above.

On the other hand, if it is determined in step S82 that the authentication ID (Auth_id) has been assigned to the noticed entry, that is, if there is, in the provisional table (FIG. 8), the other entry whose common object similar to the common object of the noticed entry has been registered, the process proceeds to step S84 in which the community generation unit 73 performs a security process to register an authentication table entry corresponding to the noticed entry to which authentication ID (Auth_id) has been assigned or an authentication table entry corresponding to a provisional table entry whose common object similar to the common object of the noticed entry has been registered, in the authentication table (FIGS. 9 and 15). The process then proceeds to step S85. Here, the security process will be described in detail afterward.

In step S85, the community generation unit 73 determines whether there is, in the authentication table, an authentication table entry to which the same authentication ID (Auth_id) as the authentication ID (Auth_id) assigned to the noticed entry of the provisional table has been assigned.

If it is determined in step S85 that there is, in the authentication table, no authentication table entry to which the same authentication ID (Auth_id) as the authentication ID (Auth_id) assigned to the noticed entry of the provisional table has been assigned, the process returns to step S81.

Further, if it is determined in step S85 that there is, in the authentication table, the authentication table entry to which the same authentication ID (Auth_id) as the authentication ID (Auth_id) assigned to the noticed entry of the provisional table has been assigned, the process proceeds to step S86 in which the community generation unit 73 detects an authentication table entry to which the same authentication ID (Auth_id) as the authentication ID (Auth_id) assigned to the noticed entry of the provisional table has been assigned (hereinafter also referred to as the same authentication ID entry), from the authentication table (FIG. 9).

Also, the community generation unit 73 generates a community in which the user (of the mobile terminal 11) specified by the terminal ID (i_uid) registered in the same authentication ID entry can participate.

That is, the community generation unit 73 secures a storage area as the community in which a user specified by the terminal ID (i_uid) registered in the same authentication ID entry (hereinafter also referred to as an authorized user) can participate, and assigns the community ID (C_id) to the community.

Further, the community generation unit 73 registers the entry of the community data containing the community ID (C_id) assigned to the community or the terminal ID (i_uid) of the authorized user registered in the same authentication ID entry, in the community table (FIGS. 10 and 15), and the process proceeds from step S86 to step S87.

In step S87, the community generation unit 73 deletes, from the provisional table, the noticed entry and the provisional table entry to which the same authentication ID (Auth_id) as the authentication ID (Auth_id) of the noticed entry has been assigned, and the process proceeds to step S88.

In step S88, the community generation unit 73 causes the communication unit 61 to transmit the terminal ID (i_uid) of the authorized user and the community ID (C_id) of the community in which the authorized user can participate, to the mobile terminal 11 of the authorized user, and the process returns to step S81.

As described above, (the user of) the mobile terminal 11 receiving the terminal ID (i_uid) and the community ID (C_id) transmitted from the community generation unit 73 can participate in the community specified by the community ID (C_id).

### [Security Process]

The security process performed in step S84 of FIG. 25 has different process contents according to the security levels (S_level).

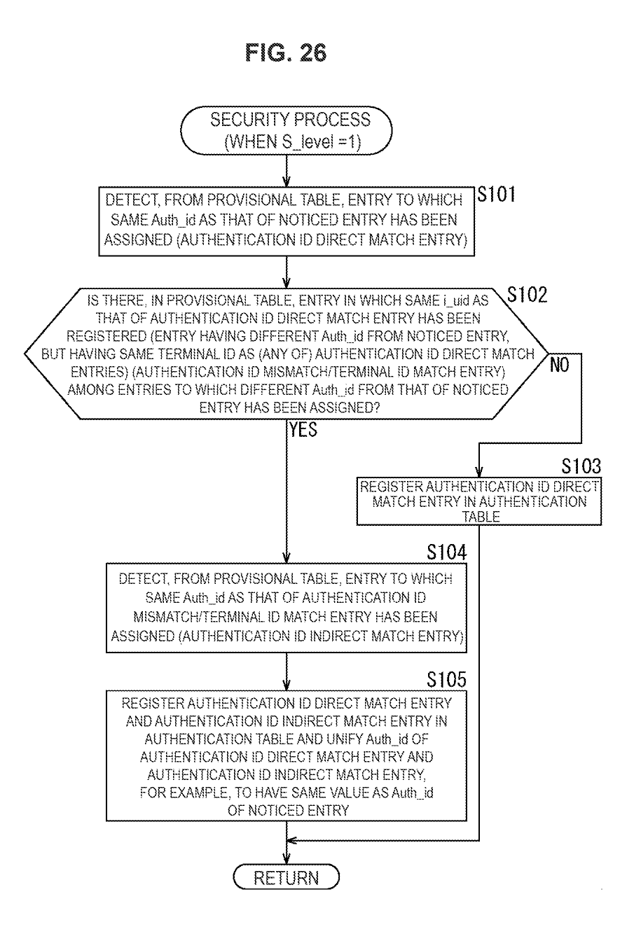

FIG. 26 is a flowchart illustrating the security process when the security level (S_level) is level 1 (when level 1 is registered in the security level (S_level) of the community table).

In step S101, the community generation unit 73 detects, from the provisional table (FIG. 15), the provisional table entry to which the same authentication ID (Auth_id) as the authentication ID (Auth_id) of the noticed entry has been assigned (hereinafter also referred to as authentication ID direct match entry), and the process proceeds to step S102.

In step S102, the community generation unit 73 determines whether there is, in the provisional table, an entry in which the same terminal ID (i_uid) as the terminal ID (i_uid) of the authentication ID direct match entry has been registered, that is, a provisional table entry having a different authentication ID (Auth_id) from the noticed entry, but having the same terminal ID (i_uid) as (any of) the authentication ID direct match entries (hereinafter, authentication ID mismatch/terminal ID match entry), among entries to which a different authentication ID (Auth_id) from the authentication ID (Auth_id) of the noticed entry has been assigned.

Here, for example, if the noticed entry is the provisional table entry #1 of FIG. 15, the provisional table entry #2 of FIG. 15 becomes an authentication ID direct match entry to which the same authentication ID (Auth_id) as the authentication ID (Auth_id) of the noticed entry has been assigned.

Further, in FIG. 15, the provisional table entry #3 matching in terminal ID with the provisional table entry #2 becomes an authentication ID mismatch/terminal ID match entry that is different in authentication ID (Auth_id) from the provisional table entry #1 that is the noticed entry, but is the same in terminal ID (i_uid) as the provisional table entry #2 that is the authentication ID direct match entry.

Accordingly, the authentication ID mismatch/terminal ID match entry and the authentication ID direct match entry refer to provisional table entries for terminal data from the same user, in which, however, (types of) registered common objects are different.

If it is determined in step S102 that there is no authentication ID mismatch/terminal ID match entry in the provisional table, the process proceeds to step S103 in which the community generation unit 73 registers an authentication table entry corresponding to the authentication ID direct match entry detected in step S101, in the authentication table (FIG. 15). Then, the process returns.

Further, if it is determined in step S102 that there is the authentication ID mismatch/terminal ID match entry in the provisional table, the process proceeds to step S104 in which the community generation unit 73 detects, from the provisional table, a provisional table entry to which the same authentication ID (Auth_id) as that of the authentication ID mismatch/terminal ID match entry has been assigned (hereinafter also referred to as authentication ID indirect match entry). The process proceeds to step S105.

Here, for example, if the noticed entry is the provisional table entry #1 of FIG. 15, the provisional table entry #4 of FIG. 15 is an authentication ID indirect match entry to which the same authentication ID (Auth_id) as the provisional table entry #3 that is the authentication ID mismatch/terminal ID match entry has been assigned.

In step S105, the community generation unit 73 registers authentication table entries corresponding to the authentication ID direct match entry detected in step S101 and the authentication ID indirect match entry detected in step S104, in the authentication table (FIG. 15).

Further, in step S105, the community generation unit 73 unifies the authentication IDs (Auth_id) of authentication table entries of the authentication table corresponding to the authentication ID direct match entries and the authentication ID indirect match entry, for example, to have the same value as the authentication ID (Auth_id) of the noticed entry of the provisional table, and the process returns.

When the security level (S_level) is level 1, a community in which the users transmitting different types of common objects are permitted to participate as described in FIG. 15 or 20 is generated by performing the security process as described above.

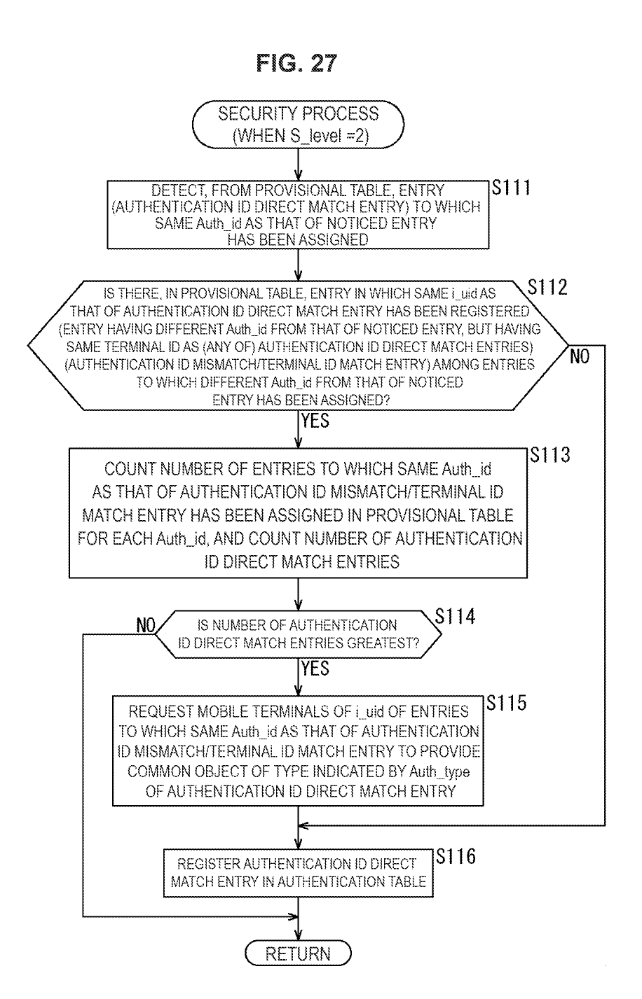

FIG. 27 is a flowchart illustrating a security process when the security level (S_level) is level 2 (when level 2 is registered in the security level (S_level) of the community table).

In step S111, the community generation unit 73 detects, from the provisional table (FIG. 18), a provisional table entry (authentication ID direct match entry) to which the same authentication ID (Auth_id) as the authentication ID (Auth_id) of the noticed entry has been assigned, and the process proceeds to step S112.

In step S112, the community generation unit 73 determines whether there is, in the provisional table, an entry in which the same terminal ID (i_uid) as the terminal ID (i_uid) of the authentication ID direct match entry has been registered, that is, a provisional table entry having a different authentication ID (Auth_id) from that of the noticed entry, but having the same terminal ID (i_uid) as (any of) the authentication ID direct match entries (authentication ID mismatch/terminal ID match entry), among entries to which a different authentication ID (Auth_id) from the authentication ID (Auth_id) of the noticed entry has been assigned.

Here, for example, when the noticed entry is assumed to be the provisional table entry #1 of FIG. 18, the provisional table entries #2 and #5 of FIG. 15 are authentication ID direct match entries to which the same authentication ID (Auth_id) as the authentication ID (Auth_id) of the noticed entry has been assigned.

Further, in FIG. 15, the provisional table entry #3 having the terminal ID matching the provisional table entry #2 that is the authentication ID direct match entry, but having the authentication ID (Auth_id) that does not match the provisional table entry #2 is the authentication ID mismatch/terminal ID match entry.

As described in FIG. 26, the authentication ID mismatch/terminal ID match entry and the authentication ID direct match entry refer to a provisional table entry for terminal data from the same user, for which, however, (types of) registered common objects are different.

If it is determined in step S112 that there is no authentication ID mismatch/terminal ID match entry in the provisional table, the process skips steps S113 to S115 and proceeds to step S116 in which the community generation unit 73 registers the authentication table entry corresponding to the authentication ID direct match entry detected in step S111, in the authentication table (FIG. 9). The process then returns.

As described above, when there is no authentication ID mismatch/terminal ID match entry in the provisional table, only an authentication table entry corresponding to the authentication ID direct match entry is registered in the authentication table (FIG. 9). Accordingly, a community in which a user specified by the terminal ID (i_uid) of the authentication ID direct match entry, that is, the provisional table entry to which the same authentication ID (Auth_id) as the authentication ID (Auth_id) of the noticed entry has been assigned, can participate is generated.

Further, if it is determined in step S112 that there is an authentication ID mismatch/terminal ID match entry in the provisional table, the process proceeds to step S113 in which the community generation unit 73 counts the entry number of the provisional table entries to which the same authentication ID (Auth_id) as the authentication ID mismatch/terminal ID match entry has been assigned in the provisional table, and counts the entry number of the authentication ID direct match entries. The process then proceeds to step S114.

Here, in step S113, the entry number of the provisional table entries to which the same authentication ID (Auth_id) as the authentication ID mismatch/terminal ID match entry has been assigned in the provisional table is counted for each authentication ID (Auth_id).

That is, the authentication ID mismatch/terminal ID match entry is the provisional table entry to which a different authentication ID (Auth_id) from the authentication ID (Auth_id) of the noticed entry has been assigned. When there are a plurality of authentication ID mismatch/terminal ID match entries in the provisional table, authentication IDs (Auth_id) of all of the plurality of authentication ID mismatch/terminal ID match entries may not match.

Since counting of the authentication ID mismatch/terminal ID match entries in step S113 is performed to check the entry number of the authentication ID mismatch/terminal ID match entries to which the same authentication ID (Auth_id) has been assigned, the counting is performed for every (the same) authentication ID (Auth_id).

In step S114, the community generation unit 73 determines whether the entry number of the authentication ID direct match entries among the provisional table entries to which the same authentication ID (Auth_id) as the authentication ID mismatch/terminal ID match entry has been assigned and the authentication ID direct match entries is greatest by comparing the results of counting the entry numbers in step S113.

If it is determined in step S114 that the entry number of the provisional table entries to which the same authentication ID (Auth_id) as the authentication ID mismatch/terminal ID match entry has been assigned among the provisional table entries to which the same authentication ID (Auth_id) as the authentication ID mismatch/terminal ID match entry has been assigned and the authentication ID direct match entries is greatest, that is, if the common object of the authentication ID direct match entry is not a winner of the majority decision, the process skips steps S115 and S116 and returns.

When the common object of the authentication ID direct match entry is not the winner of the majority decision as described above, registration of the authentication table entry in the authentication table is not performed. Accordingly, the community in which users specified by the terminal IDs (i_uid) of authentication ID direct match entries, that is, the provisional table entries to which the same authentication ID (Auth_id) as the authentication ID (Auth_id) of the noticed entry has been assigned, can participate is not generated.

On the other hand, if it is determined in step S114 that the entry number of the authentication ID direct match entries among the provisional table entries to which the same authentication ID (Auth_id) as the authentication ID mismatch/terminal ID match entry has been assigned and the authentication ID direct match entries is greatest, that is, the common object of the authentication ID direct match entry is the winner of the majority decision, the process proceeds to step S115 in which the community generation unit 73 transmits a message indicating that it is necessary to transmit a common object of the type indicated by Auth_type of the authentication ID direct match entry, that is, a common object of the same type as the common object that is the winner of the majority decision in order to participate in the community (a message for requesting a common object of the same type as the common object that is the winner of the majority decision), to the mobile terminals 11 of users specified by the terminal IDs (i_uid) of the provisional table entries to which the same authentication ID (Auth_id) as the authentication ID mismatch/terminal ID match entry has been assigned (users transmitting different types of common objects from the common object that is the winner of the majority decision). The process then proceeds to step S116.

In step S116, the community generation unit 73 registers an authentication table entry corresponding to the authentication ID direct match entry having the common object of the type that is the winner of the majority decision, in the authentication table (FIG. 9), and the process returns.

As described above, when (the type of) the common object of the authentication ID direct match entry is the winner of the majority decision, only an authentication table entry corresponding to the authentication ID direct match entry having the common object of the type that is the winner is registered in the authentication table (FIG. 9). Accordingly, a community in which the user specified by the terminal ID (i_uid) of the authentication ID direct match entry, that is, the provisional table entry to which the same authentication ID (Auth_id) as the authentication ID (Auth_id) of the noticed entry has been assigned, can participate is generated.

When the security level (S_level) is level 2, the security process as described above is performed such that the community in which the users transmitting the common object of the type that is the winner of the majority decision, that is, the similar common objects whose number is greatest, are permitted to participate is generated, as described with reference to FIG. 19 or 21.

### [Process in Community Provision System]

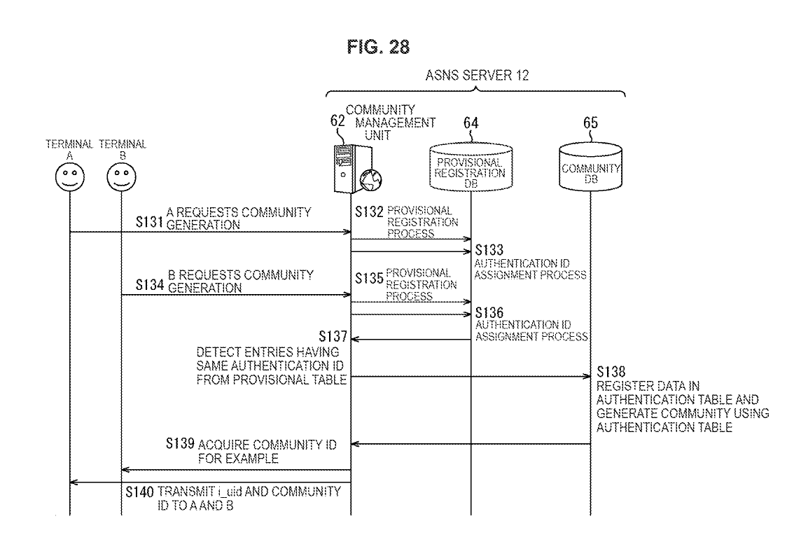

FIG. 28 is a diagram illustrating a process in which the community provision system of FIG. 1 provides a community.

Hereinafter, appropriately, a mobile terminal 11 of a certain user A is also described as terminal A, and a mobile terminal 11 of a user B different from user A is also described as terminal B.

When the users A and B desire to generate a community in which the users A and B participate, the users A and B manipulate terminals A and B to acquire similar common objects and transmit terminal data containing the common objects.

Terminal A transmits the terminal data according to the manipulation of the user A to the ASNS server 12 as a request for generation of the community in step S131.

In the ASNS server 12, the community management unit 62 (FIG. 6) receives the terminal data from terminal A, and in step S132, performs a provisional table registration process (FIG. 22) to register a provisional table entry for the terminal data from terminal A in the provisional table (FIG. 8) of the provisional registration DB 64 (FIG. 6).

Further, in step S133, the community management unit 62 in the ASNS server 12 performs the authentication ID assignment process (FIG. 24) to assign an authentication ID to the provisional table entry of the provisional table of the provisional registration DB 64.

When the authentication ID assignment process is performed in step S133, a provisional table entry having a common object similar to the common object contained in the terminal data from the user A (terminal A) is not yet registered in the provisional table registration and accordingly, at this time, an authentication ID is not yet assigned to the provisional table entry for the terminal data from the user A.

Meanwhile, terminal B transmits terminal data containing a common object similar to the common object contained in the terminal data of the user A to the ASNS server 12 as a request for generation of the community according to a manipulation of the user B in step S134.

In the ASNS server 12, the community management unit 62 receives the terminal data from terminal B and, in step S135, performs the provisional table registration process (FIG. 22) to register a provisional table entry for the terminal data from terminal B in the provisional table of the provisional registration DB 64.

Further, in step S136, the community management unit 62 in the ASNS server 12 performs the authentication ID assignment process (FIG. 24) to assign an authentication ID to the provisional table entry of the provisional table of the provisional registration DB 64.

In step S136, when the authentication ID assignment process is performed, the provisional table entry for the terminal data from the user A (hereinafter also referred to as a provisional table entry A) and a provisional table entry for the terminal data from the user B (hereinafter also referred to as provisional table entry B) are registered in the provisional table.

Also, since the common object of the provisional table entry A is similar to the common object of provisional table entry B, the same authentication ID (Auth_id) is assigned to the provisional table entries A and B.

Then, in step S137, the community management unit 62 detects the provisional table entries A and B to which the same authentication ID has been assigned from the provisional table in a community generation process (FIG. 25) in which a community in which users specified by terminal IDs registered in the provisional table entries to which the same authentication ID has been assigned can participate is generated.

In step S138, the community management unit 62 registers authentication table entries A and B corresponding to the provisional table entries A and B to which the same authentication ID has been assigned detected from the provisional table, in the authentication table (FIG. 9) of the community DB 65 (FIG. 6) in the community generation process (FIG. 25).

Further, the community management unit 62 generates a community in which the users A and B specified by terminal IDs (i_uid) registered in the authentication table entries A and B registered in the authentication table of the community DB 65 can participate in the community generation process (FIG. 25).

That is, the community management unit 62 secures a storage area as the community in which the users A and B can participate, assigns a community ID (C_id) to the community, and registers an entry of community data containing, for example, the community ID (C_id) for managing such a community in the community table of the community DB 65 (FIG. 10).

In step S139, the community management unit 62 acquires the community ID (C_id) of the community in which the users A and B can participate and the terminal IDs (i_uid) of the users A and B from the community table of the community DB 65.

In step S140, the community management unit 62 transmits the terminal ID of the user A and the community ID to terminal A and transmits the terminal ID of the user B and the community ID to terminal B.

Terminals A and B receive the terminal ID and the community ID from the community management unit 62. Also, the users A and B can perform downloading or uploading of content and exchange of messages through the community specified by the community ID by manipulating terminals A and B receiving the terminal ID and the community ID.

### [Midway Participation in Community]

According to the community provision system of FIG. 1, a plurality of users sharing a space and time can participate in the community in which the plurality of users can participate, by transmitting terminal data containing similar objects to the ASNS server 12 at a similar timing.

Incidentally, as described in FIG. 10, time_limit is registered in the entry of the community table, and after a time indicated by time_limit has elapsed, community participation of a user that has not participated in the community is limited at that time.

That is, after the time indicating time_limit of the community has elapsed, even when a non-participation user who is a user that has not participated in the community transmits a common object similar to the common object transmitted by a participation completion user that has already participated in the community, participation of the non-participation user in the community is not permitted (the terminal ID and the community ID are not provided from the ASNS server 12).

However, when participation of a user in an existing (generated) community afterward is not accepted at all, it may cause inconvenience of the community.

On the other hand, when the participation of a user in an existing (generated) community afterward is permitted indefinitely, it causes a problem on security of the community.

In the community provision system of FIG. 1, the user can participate in the existing community afterward under certain restrictions (hereinafter also referred to as midway participation).

Methods of participating in the community midway include a first midway participation method in which time_limit of the community table (FIG. 10) is changed, and a second midway participation method in which a token including a series of letters is used.

First, the first midway participation method will be described.

Hereinafter, appropriately, a mobile terminal 11 of a participation completion user who has already participated in an existing community is also referred to as a participation completion terminal, and a mobile terminal 11 of a non-participation user who has not participated in the existing community and is a user desiring to participate who desires midway participation in the community is also referred to as a terminal B desiring to participate.

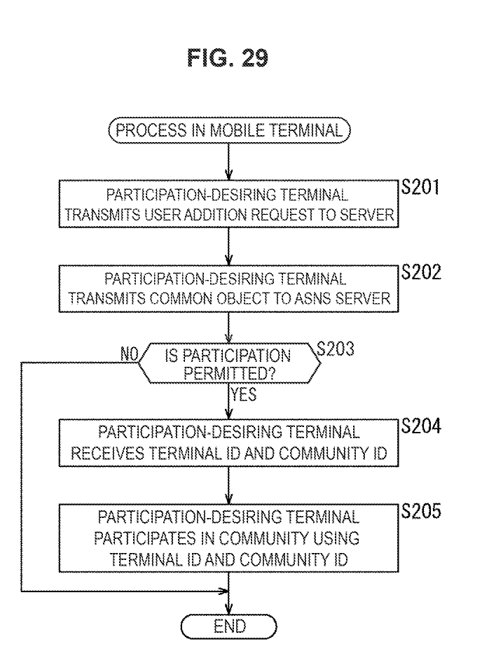

FIG. 29 is a flowchart illustrating a process in the mobile terminal 11 when the user desiring to participate participates in the community midway using the first midway participation method.

The user desiring to participate, who desires to participate in the community midway, indicates that he or she desires midway participation to a participation completion user with which a space and a time are shared.

When the participation completion user accepts the midway participation of the user desiring to participate, the participation completion user manipulates the mobile terminal 11 as a participation completion terminal (e.g., manipulates a button provided in the participation completion terminal to request midway participation) to transmit a user addition request for requesting an addition of a user participating in the community.

The participation completion terminal transmits the user addition request to the ASNS server 12 according to a manipulation of a participation completion user in step S201.

Meanwhile, the user desiring to participate, who desiresg to participate in the community midway, activates a client program and then manipulates the mobile terminal 11 as a terminal B desiring to participate owned by the user desiring to participate to acquire a common object.

In the terminal B desiring to participate, the client program is activated and, in step S202, a common object (a common object similar to the common object that the participation completion user has already transmitted) is acquired according to a user manipulation. Also, in the terminal B desiring to participate, terminal data containing the common object is transmitted to the ASNS server 12.

Then, in step S203, the terminal B desiring to participate determines whether the participation in (access to) the community is permitted by the ASNS server 12.

If it is determined in step S203 that the participation in the community has not been permitted, that is, if the community ID (C_id) of the community in which the participation completion user has participated and the terminal ID (i-uid) for identifying the terminal B desiring to participate have not been transmitted from the ASNS server 12, the process skips steps S204 and S205 and ends.

Further, if it is determined in step S203 that the participation in the community has been permitted, that is, if the community ID (C_id) of the community in which the participation completion user has participated and the terminal ID (i-uid) for identifying the terminal B desiring to participate has been transmitted from the ASNS server 12, the process proceeds to step S204 in which the terminal B desiring to participate receives the community ID and the terminal ID from the ASNS server 12. The process then proceeds to step S205.

In step S205, the terminal B desiring to participate participates in the community using the community ID and the terminal ID from the ASNS server 12.

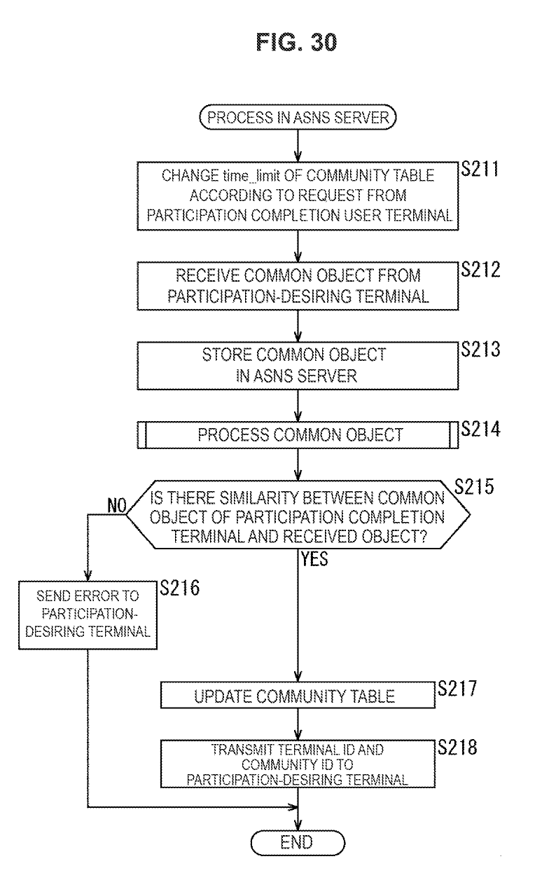

FIG. 30 is a flowchart illustrating a process in the ASNS server 12 when the user desiring to participate participates in the community midway using the first midway participation method.

When the user addition request is received from the participation completion terminal, the ASNS server 12 changes time_limit of the community table (FIG. 10) for managing the community in which the participation completion user has participated to a time obtained by adding a predetermined time to the current time according to the user addition request in step S211.

That is, for example, when the current time is 19:01:20, the ASNS server 12 changes time_limit, for example, to 19:01:50, which is a time obtained by adding a predetermined time of 30 seconds to the current time.

Further, the predetermined time added to the current time to change time_limit is not limited to, for example, 30 seconds. Also, the predetermined time may be set in the ASNS server 12 in advance or may be designated by the participation completion user manipulating the participation completion terminal.

Further, the predetermined time set in the ASNS server 12 in advance and time_limit changed using such a predetermined time may be changed to a different time by the participation completion user manipulating the participation completion terminal.

In step S212, the ASNS server 12 waits for terminal data containing a common object to be transmitted from the terminal B desiring to participate, and receives (gets) the terminal data.

In step S213, the ASNS server 12 assigns a terminal ID (i_uid) to (the user desiring to participate of) the terminal B desiring to participate transmitting the terminal data, generates a provisional table entry for the terminal data from the terminal B desiring to participate, containing for example the terminal ID, and registers (stores) the provisional table entry in the provisional table (FIG. 8).

In step S214, the ASNS server 12 performs a common object processing (FIG. 23) to process the common object of the provisional table entry for the terminal data from the terminal B desiring to participate.

In step S215, when the ASNS server 12 generates the community in which the participation completion user has participated, the ASNS server 12 determines whether the common object (contained in the terminal data) transmitted by the participation completion user and the common object contained in the terminal data from the terminal B desiring to participate (the common object of the provisional table entry for the terminal data from the terminal B desiring to participate) are similar to each other, based on object analysis data obtained through the common object processing performed in step S214.

If it is determined in step S215 that the common object transmitted by the participation completion user and the common object contained in the terminal data from the terminal B desiring to participate are not similar to each other, the process proceeds to step S216 in which the ASNS server 12 transmits an error message indicating that it is difficult to participate in the community midway with the common object not similar to the common object transmitted by the participation completion user to the terminal B desiring to participate. The process then ends.

Further, if it is determined in step S215 that the common object transmitted by the participation completion user and the common object contained in the terminal data from the terminal B desiring to participate are similar to each other, the process proceeds to step S217 in which the ASNS server 12 updates the community table (FIG. 10).

That is, in step S217, the ASNS server 12 updates the community table to be in a state in which the user desiring to participate can participate in the community in which the participation completion user has participated, by adding the terminal ID (i_uid) of the user desiring to participate to the entry of the community data of the community in which the participation completion user has participated in the community table (FIG. 10).

Further, the updating of the community table in step S217, that is, the addition of the terminal ID (i_uid) to the entry of the community table, is limited when the time indicated by time_limit (FIG. 10) of the entry has elapsed.

In step S218, the ASNS server 12 transmits the community ID of the community in which the participation completion user has participated and the terminal ID of the participation completion user to the terminal B desiring to participate. The process then ends.

The terminal B desiring to participate receiving the community ID and the terminal ID can participate in the community (midway) using the community ID and the terminal ID, as described with reference to FIG. 29.

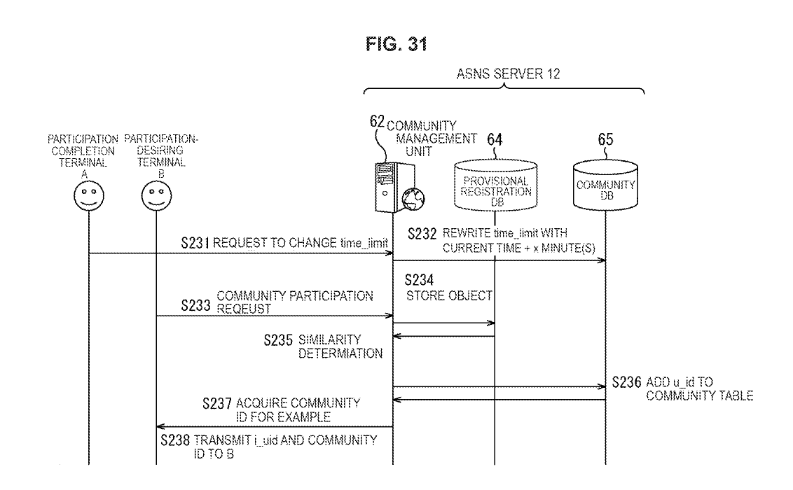

FIG. 31 is a diagram illustrating a process in the community provision system of FIG. 1 when a user desiring to participate participates in a community midway using the first midway participation method.

Here, a user A is assumed to be a participation completion user and a user B is assumed to be a user desiring to participate. Hereinafter, appropriately, a mobile terminal 11 of the participation completion user A is also described as participation completion terminal A, and a mobile terminal 11 of the user B desiring to participate is also described as terminal B desiring to participate.

When the participation completion user A receives a request for midway participation in the community in which participation completion user A has participated from the user B desiring to participate and accepts the request, the participation completion user A manipulates participation completion terminal A to transmit a user addition request.

Participation completion terminal A transmits the user addition request to the ASNS server 12 as a request to change time_limit of the community table according to the manipulation of the participation completion user A in step S231.

In the ASNS server 12, the community management unit 62 (FIG. 6) receives the user addition request from participation completion terminal A and, in step S232, changes (rewrites) time_limit of the entry of the community data for managing the community in which the participation completion user A has participated in the community table (FIG. 10) of the community DB 65 (FIG. 6), to a time obtained by adding a predetermined time to the current time according to the user addition request from participation completion terminal A.

Meanwhile, after the user B desiring to participate sends a request for midway participation in the community to the participation completion user A, the user B desiring to participate manipulates terminal B desiring to participate to acquire a common object and transmits terminal data containing the common object.

In step S233, terminal B desiring to participate transmits the terminal data containing a common object similar to the common object contained in the terminal data that the participation completion user A has transmitted when generating the community, to the ASNS server 12 as a request for generation of the community according to the manipulation of the user B desiring to participate.

In the ASNS server 12, the community management unit 62 receives the terminal data from terminal B desiring to participate and, in step S234, performs a provisional table registration process (FIG. 22) to register a provisional table entry for the terminal data from terminal B desiring to participate in the provisional table of provisional registration DB 64.

Further, in step S235, the community management unit 62 in the ASNS server 12 performs a similarity determination (a determination of the similarity) as to whether the common object from the user B desiring to participate of the provisional table entry of the provisional table of the provisional registration DB 64 is similar to the common object that the participation completion user A has transmitted when generating the community.

Also, when the common object from the user B desiring to participate is similar to the common object the participation completion user A has transmitted when generating the community, the community management unit 62 adds the terminal ID (i_uid) of the user B desiring to participate to the entry of the community data of the community in which the participation completion user A has participated, of the community table of the community DB 65, in step S236.

In step S237, the community management unit 62 acquires the community ID (C_id) of the community in which the participation completion user A has participated and the terminal ID (i_uid) of the user B desiring to participate from the community table of the community DB 65.

In step S238, the community management unit 62 transmits the terminal ID (i_uid) of the user B desiring to participate and the community ID (C_id) to terminal B desiring to participate.

Terminal B desiring to participate receives the terminal ID and the community ID from the community management unit 62. Also, the user B desiring to participate can perform downloading or uploading of content, exchange of messages and the like through the community specified by the community ID by manipulating terminal B desiring to participate, which receives the terminal ID and the community ID.

Next, the second midway participation method will be described.

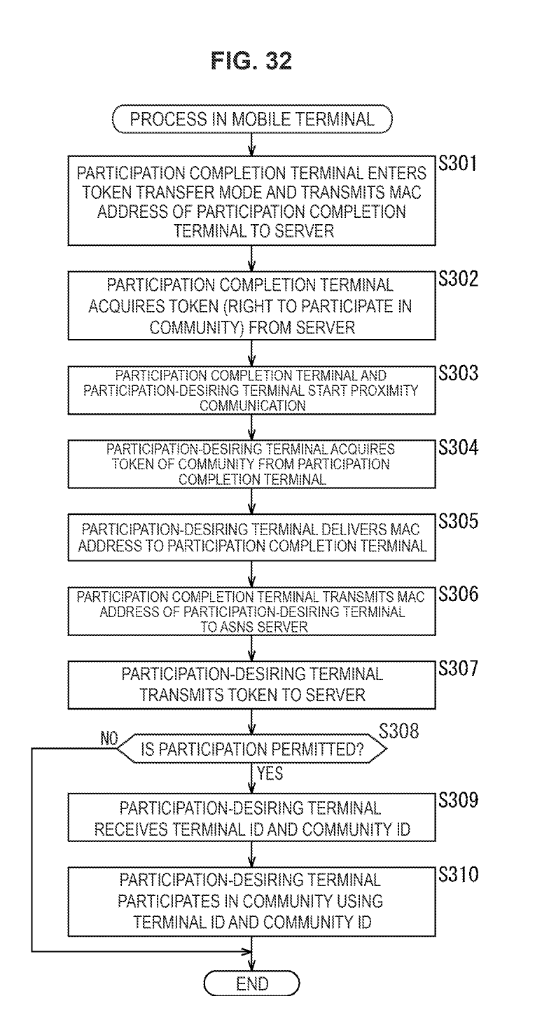

FIG. 32 is a flowchart illustrating a process in the mobile terminal 11 when the user B desiring to participate participates in a community midway using the second midway participation method.

The user B desiring to participate, who desiresg to participate in the community midway, indicates that he or she desires midway participation to the participation completion user A with which a space and a time are shared.

When the participation completion user A accepts the midway participation of the user B desiring to participate, the participation completion user A manipulates a mobile terminal 11 as participation completion terminal A so that an operation mode is a token transfer mode in which transfer of a token is performed with the ASNS server 12.

Participation completion terminal A sets the operation mode to the token transfer mode and transmits a MAC address of participation completion terminal A to the ASNS server 12 to request a token from the ASNS server 12 according to the manipulation of the participation completion user A in step S301.

In step S302, participation completion terminal A waits for the token to be transmitted from the ASNS server 12, and acquires (receives) the token from the ASNS server 12.

Here, the token transmitted from the ASNS server 12 to participation completion terminal A functions as a right to participate in the community (midway).

In step S303, participation completion terminal A and terminal B desiring to participate start proximity communication, such as NFC.

In step S304, terminal B desiring to participate acquires the token that participation completion terminal A has acquired from the ASNS server 12, from participation completion terminal A through the proximity communication.

In step S305, terminal B desiring to participate transmits (delivers) a MAC address of terminal B desiring to participate to participation completion terminal A through the proximity communication.

In step S306, participation completion terminal A transmits, to the ASNS server 12, the MAC address of terminal B desiring to participate received from terminal B desiring to participate.

In step S307, terminal B desiring to participate transmits the token acquired from the participation completion terminal A together with the MAC address of terminal B desiring to participate to the ASNS server 12 through the proximity communication.

Then, in step S308, terminal B desiring to participate determines whether the participation in (access to) the community is permitted by the ASNS server 12.

If it is determined in step S308 that the participation in the community has not been permitted, that is, if the community ID (C_id) of the community in which the participation completion user A has participated and the terminal ID (i-uid) for identifying terminal B desiring to participate have not been transmitted from the ASNS server 12, the process skips steps S309 and S310 and ends.

Further, if it is determined in step S308 that the participation in the community has been permitted, that is, if the community ID (C_id) of the community in which the participation completion user A has participated and the terminal ID (i-uid) for identifying terminal B desiring to participate have been transmitted from the ASNS server 12, the process proceeds to step S309 in which terminal B desiring to participate receives the community ID and the terminal ID from the ASNS server 12. The process then proceeds to step S310.

In step S310, terminal B desiring to participate participates in the community using the community ID and the terminal ID from the ASNS server 12.

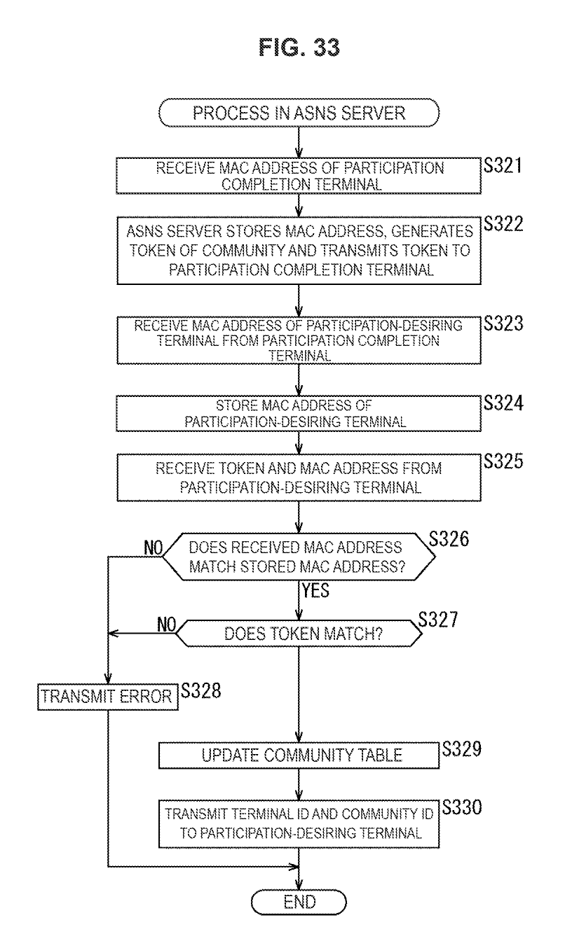

FIG. 33 is a flowchart illustrating a process in the ASNS server 12 when the user B desiring to participate participates in the community midway using the second midway participation method.

When a MAC address of participation completion terminal A is received from participation completion terminal A in the token transfer mode, the ASNS server 12 receives the MAC address of participation completion terminal A (hereinafter also described as a MAC address A) in step S321.

In step S322, the ASNS server 12 temporarily stores (records) the MAC address A of participation completion terminal A from participation completion terminal A.

Also, in step S322, the ASNS server 12 checks if the MAC address A has been registered in the community table. If the MAC address A has been registered in the community table, that is, if the MAC address A is the MAC address of the mobile terminal 11 of the user participating in the previously generated community, for example, the ASNS server 12 issues a random number as a token and transmits the token to participation completion terminal A transmitting the MAC address A.

In step S323, the ASNS server 12 waits for the MAC address of terminal B desiring to participate (hereinafter also described as a MAC address B) to be transmitted from participation completion terminal A, and receives the MAC address B.

In step S324, the ASNS server 12 temporarily stores the MAC address B of terminal B desiring to participate from participation completion terminal A.

In step S325, the ASNS server 12 waits for the MAC address B of terminal B desiring to participate and the token to be transmitted from terminal B desiring to participate, and receives the MAC address B and the token.

Also, in step S326, the ASNS server 12 determines whether the MAC address B received from terminal B desiring to participate in step S325 (hereinafter also referred to as a received MAC address) matches the MAC address B of terminal B desiring to participate from participation completion terminal A stored in step S324 (hereinafter also referred to as a stored MAC address).

If it is determined in step S326 that the received MAC address does not match the stored MAC address, the process proceeds to step S327 in which the ASNS server 12 regards the mobile terminal 11 transmitting the received MAC address as being likely to be terminal B desiring to participate, and transmits an error message to the mobile terminal 11 transmitting the received MAC address. The process then ends.

Further, if it is determined in step S326 that the received MAC address matches the stored MAC address, the process proceeds to step S328 in which the ASNS server 12 determines whether the token received from terminal B desiring to participate in step S325 (hereinafter also referred to as a received token) and the token issued in step S322 (hereinafter also referred to as an issued token) match.

If it is determined in step S328 that the received token and the issued token do not match, the process proceeds to step S327 in which the ASNS server 12 regards the mobile terminal 11 transmitting the received token as being likely to be terminal B desiring to participate, and transmits the error message to mobile terminal 11 transmitting the received token. The process then ends.

Further, if it is determined in step S328 that the received token and the issued token match, the process proceeds to step S329 in which the ASNS server 12 updates the community table (FIG. 10).

That is, in step S329, the ASNS server 12 updates the community table to be in a state in which the user B desiring to participate can participate in the community in which the participation completion user A has participated, by adding the terminal ID of the user B desiring to participate to the entry of the community data of the community in which the participation completion user A has participated in the community table (FIG. 10).

Further, the updating of the community table in step S329, that is, the addition of the terminal ID of the entry of the community table, is not limited even when a time indicated by time_limit of the entry has elapsed.

In step S330, the ASNS server 12 transmits the community ID of the community in which the participation completion user A has participated and the terminal ID of the participation completion user to the terminal B desiring to participate, and the process ends.

The terminal B desiring to participate, which receives the community ID and the terminal ID, can participate in the community (midway) using the community ID and the terminal ID as described in FIG. 32.

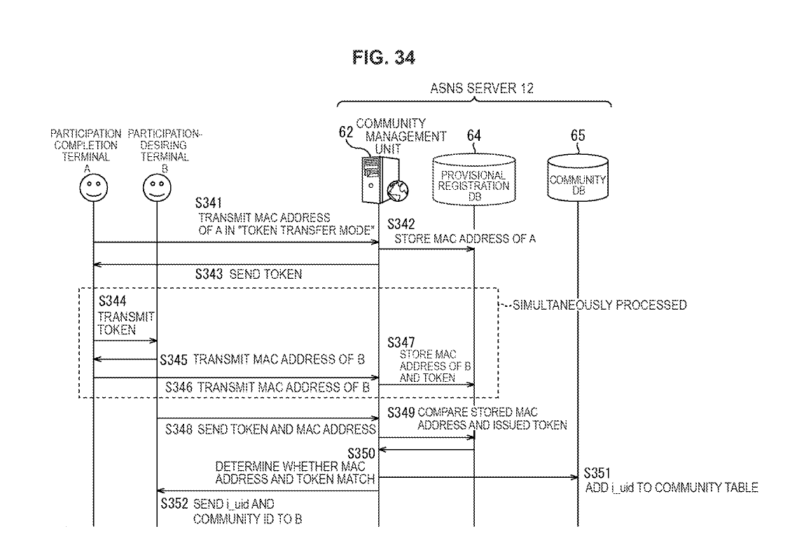

FIG. 34 is a diagram illustrating a process in the community provision system of FIG. 1 when the user desiring to participate participates in the community midway using the second midway participation method.

The participation completion user A receives a request for midway participation in the community in which the participation completion user A has participated from the user B desiring to participate. When the participation completion user A accepts the request, the participation completion user A manipulates participation completion terminal A to enter a token transfer mode.

Participation completion terminal A sets an operation mode to the token transfer mode according to the manipulation of the participation completion user A in step S341, and transmits a MAC address of the participation completion terminal A to the ASNS server 12.

In the ASNS server 12, the community management unit 62 (FIG. 6) receives the MAC address A from the participation completion terminal A and temporarily stores the MAC address A, for example, in the provisional registration DB 64 in step S342.

In step S343, the community management unit 62 issues a token and transmits the token to participation completion terminal A transmitting the MAC address A.

Participation completion terminal A receives the token from the community management unit 62, and starts proximity communication with terminal B desiring to participate.

That is, in step S344, participation completion terminal A transmits the token to terminal B desiring to participate through the proximity communication, and terminal B desiring to participate receives the token from participation completion terminal A.

In step S345, terminal B desiring to participate transmits a MAC address B of terminal B desiring to participate to participation completion terminal A through the proximity communication, and participation completion terminal A receives the MAC address B from terminal B desiring to participate.

Then, in step S346, participation completion terminal A transmits the MAC address B from terminal B desiring to participate to the community management unit 62.

The community management unit 62 receives the MAC address B from the participation completion terminal A, and in step S347, temporarily stores the MAC address B to be associated with the token issued in step S343, for example, in the provisional registration DB 64.

In step S348, terminal B desiring to participate transmits the MAC address B of terminal B desiring to participate and the token acquired from participation completion terminal A through proximity communication, to the community management unit 62.

The community management unit 62 receives the MAC address B and the token from terminal B desiring to participate, and in step S349, compares the issued token that is a token stored in the provisional registration DB 64 and the stored MAC address that is the MAC address B stored in the provisional registration DB 64 to be associated with the issued token, with the received token and the received MAC address, which are the token and the MAC address B received from terminal B desiring to participate.

In step S350, the community management unit 62 determines whether the issued token matches the received token and the stored MAC address matches the received MAC address as a result of comparing the issued token and the stored MAC address with the received token and the received MAC address in step S349.

When the issued token matches the received token and the stored MAC address matches the received MAC address, the community management unit 62 adds the terminal ID (i_uid) of the user B desiring to participate to the entry of the community data of the community in which the participation completion user A has participated of the community table of the community DB 65 in step S351.

In step S352, the community management unit 62 acquires the community ID (C_id) of the community in which the participation completion user A has participated and the terminal ID (i_uid) of the user B desiring to participate from the community table of the community DB 65.

Further, in step S352, the community management unit 62 transmits the terminal ID of the user B desiring to participate and the community ID (i_uid) to terminal B desiring to participate.

Terminal B desiring to participate receives the terminal ID and the community ID from the community management unit 62. Also, the user B desiring to participate can perform downloading or uploading of content, exchange of messages and the like through the community specified by the community ID by manipulating terminal B desiring to participate, which receives the terminal ID and the community ID.

With the second midway participation method, it is possible to prevent spoofing of terminal B desiring to participate by using the token and the MAC address.

Further, with the second midway participation method, it is unnecessary for terminal B desiring to participate to transmit the common object to the ASNS server 12.

Further, an expiration date is set in the token. The token whose expiration date has elapsed is invalid, and the ASNS server 12 does not perform a process for the invalid token.

According to the present technology, it is possible to use the community more safely and more simply.

Further, according to the present technology, it is possible to generate a highly convenient community, for example, in a bus trip, a wedding ceremony, a concert such as a rock festival, a meeting in a company, an exhibition, or the like.

Specifically, for example, strangers come together on a bus trip. In this case, participants of the bus trip temporarily perform communication, but the communication, for example, using email exchange is complex. Also, it is troublesome in the bus trip for any of the participants of the bus trip to create an SNS community in related art and invite other participants to the community.

On the other hand, when the community according to an embodiment of the present technology is created in the bus trip, secure communication can be achieved. Further, according to the community of an embodiment of the present technology, the participant of the bus trip can share photographs or videos captured by other participants without revealing personal information such as an email address.

Next, for example, in a wedding ceremony, most participants of the wedding ceremony are unacquainted with each other, but the community according to an embodiment of the present technology enables photographs, videos, messages and the like of the bride and groom to be simply shared.

Further, since the midway participation is possible in the community according to an embodiment of the present technology, participants of a second party or a third party of the wedding ceremony can participate in a community created in the wedding ceremony midway. Accordingly, when videos captured in the wedding ceremony are uploaded to the community, events occurring in the wedding ceremony can be shared between participants of the wedding ceremony and the participants of, for example, the second party.

Next, for example, in events such as rock festivals or concerts of artists of various musical genres, favorite hobbies and musical genre are disparate between users participating in the same event.

When the community according to an embodiment of the present technology is created for each artist of the event, users having the same favorite musical genres can easily discover each other.

Further, a user can participate in one or more communities and commonality between the users participating in the community (e.g., the number of users participating in both a certain community and another community) is presented to the user as correlation between communities, for example, such that the user can discover a musical genre not recognized as a favorite musical genre that is common in users to the musical genre recognized as the favorite musical genre.

Next, for example, for a meeting outside a company, first acquainted people in the meeting outside the company can create the community according to an embodiment of the present technology. When participants of the meeting outside the company have, for example, smart phones, it is possible to analyze voices of the users and accumulate the voices in the community according to an embodiment of the present technology using the smart phones. In this case, the community can be used as a log for storing speech of the participants and the log can be usefully used to produce proceedings in the future.

Next, for example, for the exhibition, for example, voices of users participating in business talk in the exhibition can be accumulated in the community according to an embodiment of the present technology. In this case, the community can be used as a log for storing speech of users participating in the business talk, and atmosphere in the business talk can be recognized or reputation of the exhibition can be investigated from the log in the future.

Here, in this disclosure, processes that a computer performs according to a program are not necessarily sequentially performed in the orders described in the flowcharts. That is, the processes that the computer performs according to the program also include processes executed in parallel or individually (e.g., a parallel process or an object-based process).

Further, the program may be processed by one computer (processor) or may be processed in a distributive manner by a plurality of computers. Also, the program may be transmitted to and executed by a remote computer.

The embodiments of the present technology are not limited to the above-described embodiments and various changes may be made without departing from the spirit and scope of the present technology.

Additionally, the present technology may also be configured as below.

(1) An information processing device, including:

an acquisition unit for acquiring information transmitted from terminals; and

a generation unit for generating a community according to a similarity degree between the information transmitted from a plurality of terminals,

wherein, when a plurality of different types of information are transmitted from one terminal, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.

(2) The information processing device according to (1), wherein the community generation unit generates the community based on a predetermined security level.
(3) The information processing device according to (2), wherein

the security level includes at least
a first level in which pieces of information transmitted from terminals of a plurality of users participating in a community is allowed to be different types of information, and
a second level in which it is necessary for pieces of information transmitted from terminals of a plurality of users participating in a community to be the same type of information,

when the security level is the first level, the community generation unit generates a community in which a user of a terminal is permitted to participate, the terminal transmitting information similar to any of the plurality of types of information, and

when the security level is the second level, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.

(4) The information processing device according to any one of (1) to (3), wherein

a terminal transmitting information of a different type from the information transmitted by the greatest number of terminals is requested to transmit information of the same type as the information transmitted by the greatest number of terminals.

(5) An information processing method, including:

acquiring information transmitted from terminals; and

generating a community according to a similarity degree between the information transmitted from a plurality of terminals,

wherein, when a plurality of different types of information are transmitted from one terminal, the generation of the community includes counting, for each of the plurality of types of information, the number of terminals transmitting information similar to the information, and generating a community in which a user of a terminal is permitted to participate, the terminal transmitting information similar to information which the greatest number of terminals transmit information similar to.

(6) A program for causing a computer to function as:

an acquisition unit for acquiring information transmitted from terminals; and

a generation unit for generating a community according to a similarity degree between the information transmitted from a plurality of terminals,

wherein, when a plurality of different types of information are transmitted from one terminal, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.

The present disclosure contains subject matter related to that disclosed in Japanese Priority Patent Application JP 2011-163366 filed in the Japan Patent Office on Jul. 26, 2011, the entire content of which is hereby incorporated by reference.

What is claimed is:

1. An information processing device, comprising:
an acquisition unit for acquiring information transmitted from terminals; and
a generation unit for generating a community according to a similarity degree between the information transmitted from a plurality of terminals,
wherein, when a plurality of different types of information are transmitted from one terminal, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.

2. The information processing device according to claim 1, wherein the community generation unit generates the community based on a predetermined security level.

3. The information processing device according to claim 2, wherein
the security level includes at least
a first level in which pieces of information transmitted from terminals of a plurality of users participating in a community is allowed to be different types of information, and
a second level in which it is necessary for pieces of information transmitted from terminals of a plurality of users participating in a community to be the same type of information,
when the security level is the first level, the community generation unit generates a community in which a user of a terminal is permitted to participate, the terminal transmitting information similar to any of the plurality of types of information, and
when the security level is the second level, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.

4. The information processing device according to claim 3, wherein
a terminal transmitting information of a different type from the information transmitted by the greatest number of terminals is requested to transmit information of the same type as the information transmitted by the greatest number of terminals.

5. An information processing method, comprising:
acquiring information transmitted from terminals; and
generating a community according to a similarity degree between the information transmitted from a plurality of terminals,
wherein, when a plurality of different types of information are transmitted from one terminal, the generation of the community includes counting, for each of the plurality of types of information, the number of terminals transmitting information similar to the information, and generating a community in which a user of a terminal is permitted to participate, the terminal transmitting information similar to information which the greatest number of terminals transmit information similar to.

6. A program for causing a computer to function as:
an acquisition unit for acquiring information transmitted from terminals; and
a generation unit for generating a community according to a similarity degree between the information transmitted from a plurality of terminals,
wherein, when a plurality of different types of information are transmitted from one terminal, the community generation unit counts, for each of the plurality of types of information, the number of terminals transmitting information similar to the information, and generates a community in which a user of a terminal is permitted to participate, the terminal transmitting information similar to information which the greatest number of terminals transmit information similar to.
